(19) United States
(12) Patent Application Publication
(10) Pub. No.: US 2025/0188097 A1
(43) Pub. Date: Jun. 12, 2025

(54) ORGANOBORON COMPOUND, ITS PREPARATION AND USE

(71) Applicant: City University of Hong Kong, Kowloon (HK)

(72) Inventors: Zhenpin Lu, Kowloon (HK); Haokun Li, Kowloon (HK)

(21) Appl. No.: 18/788,711

(22) Filed: Jul. 30, 2024

Related U.S. Application Data
(60) Provisional application No. 63/608,397, filed on Dec. 11, 2023.

(51) Int. Cl. C07F 5/02

(52) U.S. Cl. CPC C07F 5/027

(57) ABSTRACT

An organoboron compound for reductive synthesis includes a structure of Formula (I). A method for preparing the organoboron compound includes providing a first precursor having a structure of Formula (IV), with R₁ and R₂ each being the mono-, di or tri substitution, and converting the first precursor into the organoboron compound.

### TECHNICAL FIELD

The present invention relates to an organoboron compound, for example, particularly, but not exclusively, an anionic or neutral organoboron compound for reductive synthesis and the preparation for such an organoboron compound.

### BACKGROUND OF THE INVENTION

The elements in Group 1 of the Periodic Table are characterized by having the lowest electronegativity values. Thus, it is believed that the chemical reduction of Group-1 metal cations M⁺ to form their corresponding zero-valent species M(0) is exceptionally rare and represents one of the most challenging endeavors in the field of synthetic inorganic chemistry, compared to electrochemical and photochemical regimes. It is also believed that one major hurdle is the absence of a suitable reducing agent capable of surpassing the highly negative redox potential.

Attempts to achieve such a reduction reaction, such as using low-valent magnesium species, heterobimetallic electride, chloroberyllate compounds, have been reported. These reactions/approaches, however, generally require the use/presence of special ligands within the metal-containing system and/or complicated/harsh synthetic procedures.

The present invention thus seeks to eliminate or at least mitigate such shortcomings by providing a new or otherwise improved reducing agent, such as reducing agent comprising an organoboron compound for such a reductive reaction.

### SUMMARY OF THE INVENTION

In a first aspect of the present invention, there is provided an organoboron compound for reductive synthesis comprising a structure of Formula (I):

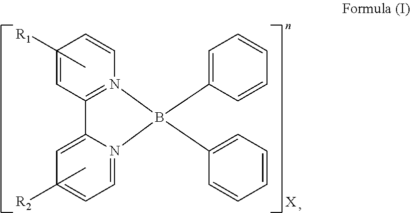

wherein R₁ and R₂ each are mono-, di- or tri-substitution; n is an integer; and X, if present, is a counterion.

Optionally, R₁ and R₂ are each independently selected from the group consisting of hydrogen, alkyl, alkoxy and a combination thereof; and with n and X as defined above.

It is optional that R₁ and R₂ are each independently selected from the group consisting of hydrogen, C1-C5 linear or branched alkyl, C1-C5 alkoxy and a combination thereof; and with n and X as defined above.

In an optional embodiment, the organoboron compound comprises a structure of Formula (IA):

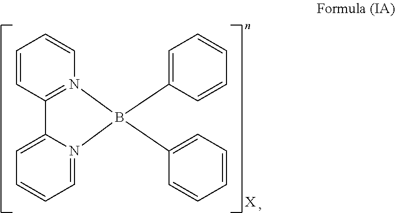

wherein n is 0 or −1; and X, if present, comprises a positive counterion.

Optionally, the organoboron compound comprises a structure of Formula (II):

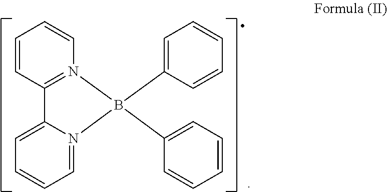

It is optional that the organoboron compound comprises a structure of Formula (III):

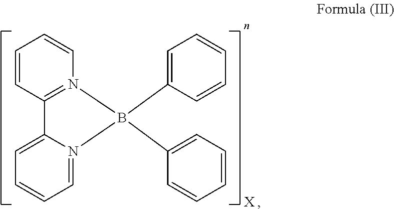

with X being the positive counterion.

In an optional embodiment, the organoboron compound comprises a structure of Formula (IIIA) or Formula (IIIB):

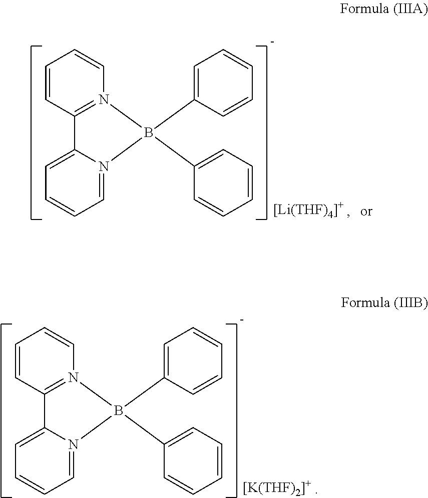

Optionally, the reductive synthesis comprises any one of metallic lithium (Li(0)) formation, P—P coupling reaction, Sn—Sn coupling reaction, Se—Se coupling reaction, Ge—Ge coupling reaction, H—H coupling reaction, C—C coupling reaction, alkene reduction reaction and CO₂ reduction reaction.

In a second aspect of the present invention, there is provided a method for preparing an organoboron compound in accordance with the first aspect, comprising the steps of:
(a) providing a first precursor having a structure of Formula (IV):

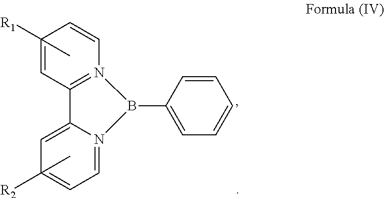

with R₁ and R₂ each being the mono-, di or tri substitution as defined above; and
(b) converting the first precursor into the organoboron compound.

In an optional embodiment, the first precursor has a structure of Formula (IVA):

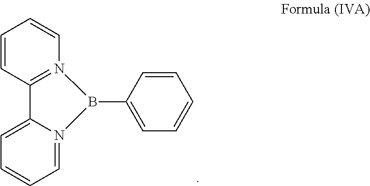

Optionally, the method comprises the step of converting the first precursor having the structure of Formula (IVA) into the organoboron compound at room temperature.

In an optional embodiment, the converting step includes stirring a first reaction mixture comprising the first precursor having the structure of Formula (IVA), phenyllithium and THF at room temperature for at least 8 hours to form the organoboron compound having the structure of Formula (II).

Optionally, the first precursor having the structure of Formula (IVA) and phenyllithium have a molar ratio of about 1:1.5.

In optional embodiment, the converting step includes stirring a second reaction mixture comprising the first precursor having the structure of Formula (IVA), phenyllithium and toluene at room temperature for at least 8 hours to form the organoboron compound having the structure of Formula (IIIA).

It is optional that the first precursor having the structure of Formula (IVA) and phenyllithium have a molar ratio of about 1:1.

Optionally, the converting step further includes stirring a third reaction mixture comprising the organoboron compound having the structure of Formula (IIIA) and toluene at room temperature for at least 8 hours to form the organoboron compound having the structure of Formula (II).

In an optional embodiment, the converting step includes stirring a fourth reaction mixture comprising the organoboron compound having the structure of Formula (II), potassium and THF at room temperature for at least 8 hours to form the organoboron compound having the structure of Formula (IIIB).

Optionally, the organoboron compound having the structure of Formula (II) and potassium have a molar ratio of about 1:2.

In optional embodiment, the organoboron compound having the structure of Formula (IIIB) is reversibly convertible to the organoboron compound having the structure of Formula (II).

Optionally, the organoboron compound having the structure of Formula (IIIB) is reversibly converted to the organoboron compound having the structure of Formula (II) when the organoboron compound having the structure of Formula (IIIB) is heated in toluene at a temperature of about 70° C. to about 80° C. for at least 8 hours.

### BRIEF DESCRIPTION OF DRAWINGS

The invention will now be more particularly described, by way of example only, with reference to the accompanying drawings, in which:

FIG. 1 is a schematic diagram illustrating the decomposition of tetraaryl borates;

FIG. 2 is a synthetic scheme illustrating the synthesis of (bipy)BPh (4);

FIG. 3 is a synthetic scheme illustrating the synthesis of [Li(THF)₄][(bipy)BPh₂](5) from (bipy)BPh (4);

FIG. 4 is a synthetic scheme illustrating the synthesis of [K(THF)₂][(bipy)BPh₂](5′) from [(bipy)BPh₂](6);

FIG. 5A is a synthetic scheme illustrating the synthesis of [(bipy)BPh₂](6) from (bipy)BPh (4);

FIG. 5B is a synthetic scheme illustrating the synthesis of [(bipy)BPh₂](6) from [Li(THF)₄][(bipy)BPh₂](5);

FIG. 5C is a synthetic scheme illustrating the synthesis of [(bipy)BPh₂](6) from [K(THF)₂][(bipy)BPh₂](5′);

FIG. 6 is a schematic diagram illustrating the reaction of [Li(THF)₄][(bipy)BPh₂](5) nad 12-crown-4-ether in toluene;

FIG. 7 shows the EPR spectra of [Li(THF)₄][(bipy)BPh₂](5) under various reaction conditions;

FIG. 8A is a synthetic scheme illustrating the synthesis of [(bipy)BPh₂][CuCl₂](7) from [K(THF)₂][(bipy)BPh₂](5′);

FIG. 8B is a synthetic scheme illustrating the synthesis of [(bipy)BPh₂][CuCl₂](7) from [(bipy)BPh₂](6);

FIG. 9A is a schematic diagram illustrating the P—P coupling reaction assisted by [K(THF)₂][(bipy)BPh₂](5′);

FIG. 9B is a schematic diagram illustrating the P—P coupling reaction assisted by [(bipy)BPh₂](6);

FIG. 10 is a schematic diagram illustrating the Sn—Sn coupling reaction assisted by [K(THF)₂][(bipy)BPh₂](5′);

FIG. 11 is a schematic diagram illustrating the Se—Se coupling reaction assisted by [K(THF)₂][(bipy)BPh₂](5′);

FIG. 12 is a schematic diagram illustrating the Ge—Ge coupling reaction assisted by [K(THF)₂][(bipy)BPh₂](5′);

FIG. 13 is a schematic diagram illustrating the formation of H₂ assisted by [K(THF)₂][(bipy)BPh₂](5′);

FIG. 14 shows the ¹H NMR spectrum of NHEt₃Cl reactions in THF-d₈ corresponding to FIG. 13;

FIG. 15A shows the GC spectra of the NHEt₃Cl reaction corresponding to FIG. 13;

FIG. 15B shows the GC spectra of pure H₂;

FIG. 15C shows the GC spectra of pure air in laboratory setting;

FIG. 16 is a schematic diagram illustrating the direct C—C coupling of pyridine by [K(THF)₂][(bipy)BPh₂](5′);

FIG. 17 is a schematic diagram illustrating the Birch reaction of acridine assisted by [K(THF)₂][(bipy)BPh₂](5′);

FIG. 18A shows the GC spectra of CO₂ reduction assisted by [K(THF)₂][(bipy)BPh₂](5′);

FIG. 18B shows the GC spectra of pure CO;

FIG. 19 shows the ¹³C{¹H}NMR of CO₂ reactions in D₂O;

FIG. 20 is a schematic diagram illustrating the synthesis of borate anion 5 and boron radical 6. 5 was synthesized from compound 4 and PhLi, and the decomposition of 5 in toluene generated 6 and metallic lithium;

FIG. 21 shows the molecular structure of the borate anion 5 (thermal ellipsoids are set at the 50% probability level, and all hydrogen atoms are omitted for clarity). Selected bond distances (A) of compound 5: N1-B1 1.564(3), N2-B1 1.557(3), N1-C1 1.417(3), N2-C2 1.419(3), C1-C2 1.359(3);

FIG. 22 shows the molecular structure of the boron radical 6 (thermal ellipsoids are set at the 50% probability level, and all hydrogen atoms are omitted for clarity). Selected bond distances (Å) of compound 6: N1-B1 1.590(3), N2-B1 1.578(3), N1-C1 1.386(3), N2-C2 1.386(3), C1-C2 1.404(3);

FIG. 23 shows the EPR spectra of compound 6 in toluene solution at room temperature, the simulation was performed on two isotopomers (¹¹B)/(¹⁰B)=4/1, a(¹⁰B)=0.05 G, a(¹¹B)=0.16 G, a(¹⁴N)=3.57 G, a(¹H)=1.01, 7.77, 8.89, 10.77 G);

FIG. 24 shows the XPS spectra of lithium-containing products (top), commercial metallic lithium (middle), and the mixture of our lithium-containing products/commercial metallic lithium (bottom). XPS Analysis was acquired on Thermo Scientific K-Alpha;

FIG. 25 shows the powder XRD of the residue formed in the synthesis of compound 6 confirmed as Li(0);

FIG. 26A is a schematic diagram illustrating the formation of boron radical 6 and the regeneration of borate anion 5;

FIG. 26B shows the ¹¹B NMR of the borate anion 5 in toluene or in THF. Blue: toluene (EPR active); Red: removal of toluene and add THF;

FIG. 27 shows the cyclic voltammograms (CVs) of the boron radical 6 in THF solution containing 0.1 M [nBu4N][PF6]) at room temperature (scan rate: 100 mV/s);

FIG. 28 shows the cyclic voltammograms (CVs) of boron radical 6 in THF solution containing 0.1 M [nBu4N][PF6]) at room temperature with different scan rates;

FIG. 29 is a schematic diagram illustrating the formation of borate anion 5′ and boron radical 6 is controllable by different reaction conditions;

FIG. 30 is a schematic diagram illustrating either the borate anion 5′ or the boron radical 6 can undergo oxidation to yield compound 7 in the presence of CuCl;

FIG. 31 shows the molecular structure of compound 7 (thermal ellipsoids are set at the 50% probability level, and all hydrogen atoms are omitted for clarity). Selected bond distances (Å): N1-B1 1.614(6), N2-B1 1.601(6), N1-C1 1.352(6), N2-C2 1.346(6), C1-C2 1.469(6);

FIG. 32 shows the NICS(1) values of compounds 5, 6, and 7. Magnetic properties were calculated using the revTPSS/pcSseg-1 level of theory with optimized structures with the SMD solvent model;

FIG. 33A shows the AICD of boronium. The direction of magnetic field is perpendicular to the paper and point to the reader;

FIG. 33B shows the AICD of radical. The direction of magnetic field is perpendicular to the paper and point to the reader;

FIG. 33C shows the AICD of anion. The direction of magnetic field is perpendicular to the paper and point to the reader;

FIG. 34 shows the calculated LUMO and HOMO orbitals of boronium, boron radical, and boron anion (Isovalue: 0.03 a.u.);

FIG. 35 shows the calculated LUMO and HOMO orbitals of anion 5. All calculations were carried out using ORCA (version 5.0.4);

FIG. 36 shows the ³¹P{¹H}NMR in C₆D₆ for comparison (P—P), using sodium naphthalene as the reducing agent;

FIG. 37 shows the ¹¹⁹Sn{¹H}NMR of nBu₆Sn₂ in C₆D₆ (*: unknown impurity);

FIG. 38 is a schematic diagram illustrating the reaction of 5′ and CO₂ (1 atm) in THF;

FIG. 39 is a schematic diagram illustrating the reaction of CO₂ (1 atm) and K in the presence of 5 mol % of 5′ in THF; and

FIG. 40 is a schematic diagram illustrating the reaction of CO₂ (1 atm) and K without 5′ in THF.

### DETAILED DESCRIPTION OF OPTIONAL EMBODIMENT

As used herein, the forms “a”, “an”, and “the” are intended to include the singular and plural forms unless the context clearly indicates otherwise.

The words “example” or “exemplary” used in this invention are intended to serve as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A, X employs B, or X employs both A and B, then “X employs A or B” is satisfied under any of the foregoing instances.

As used herein, the phrase “about” is intended to refer to a value that is slightly deviated from the value stated herein. Various examples have been described throughout the present disclosure.

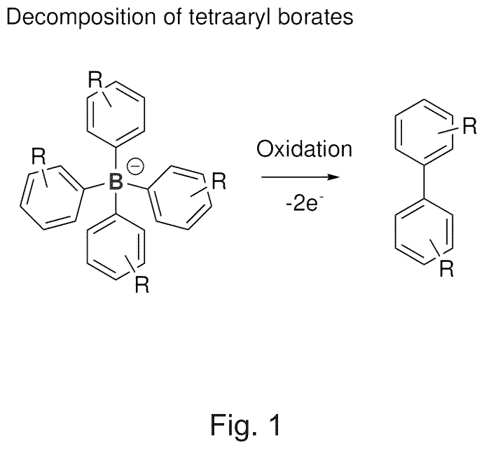

It is believed that tetraaryl borate anions are stable under ambient air conditions. However, they are not redox-active species since the corresponding boron radical and cation species are unstable and decompose under oxidizing conditions, leading to the formation of biphenyl products (FIG. 1). It is believed that installation of a non-innocent ligand at the boron atom may endow the corresponding borate anion desired redox properties.

Without wishing to be bound by theory, the inventors have, through their own research, trials, and experiments, devised that by employing bipyridine as the non-innocent ligand to the boron center, the bipyridine-coordinated borate anion would show a robust reduction ability and can realize a reduction of Li⁺ into the corresponding elemental metallic species, forming the boron radical. It is also devised that such a bipyridine-coordinated borate anion could undergo two-electron transfer to generate the corresponding boronium. It is further devised that, in some embodiments, the bipyridine-coordinated borate anion may mediate reductive homo-coupling reactions of organohalides, enabling the formation of P—P, Sn—Sn, Se—Se, and Ge—Ge bonds, and in some other embodiments, the bipyridine-coordinated borate anion may facilitate reductive pyridine coupling, the reduction of acridine and the catalytic two-electron reduction of CO₂ to CO.

In a first aspect of the present invention, there is provided an organoboron compound for reductive synthesis comprising a structure of Formula (I):

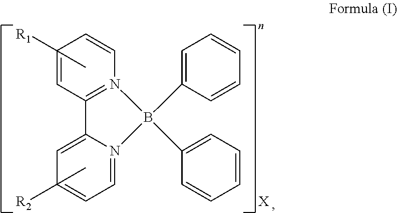

wherein R₁ and R₂ each are mono-, di- or tri-substitution; n is an integer; and X, if present, is a counterion. In some embodiments, R₁ and R₂ may be each independently selected from the group consisting of hydrogen, alkyl, alkoxy and a combination thereof.

The alkyl group may be linear or branched, and may be with 1-10 carbon atoms such as 1-5 carbon atoms (i.e., C1-C5 linear or branched alkyl). Examples of C1-C5 linear alkyl groups may include methyl, ethyl, propyl, butyl, pentyl. Examples of C1-10 branched alkyl groups may include isopropyl, n-butyl, isobutyl, sec-butyl, tert-butyl, n-pentyl (amyl), tert-pentyl, neopentyl, isopentyl (isoamyl), sec-pentyl, 3-pentyl, sec-isopentyl, active pentyl and the like.

The alkoxy group may be an alkyl group as described herein which is singularly bonded to oxygen. Examples may include methoxy, ethoxy, propoxy, butoxy, pentoxy, isopropoxy, n-butoxy, isobutoxy, sec-butoxy, tert-butoxy, n-pentoxy, tert-pentoxy, neopentoxy, isopentoxy, sec-pentoxy, 3-pentoxy, sec-isopentoxy and the like.

In some particular embodiments, the R₁ and R₂ may be identical and may be hydrogen. In these particular embodiments, the organoboron compound may comprise a structure of Formula (IA):

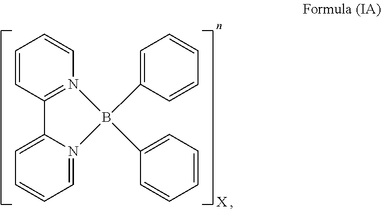

wherein n is 0 or −1; and X, if present, comprises a positive counterion.

In some embodiments where n is 0, the organoboron compound may be a radical and may comprise a structure of Formula (II):

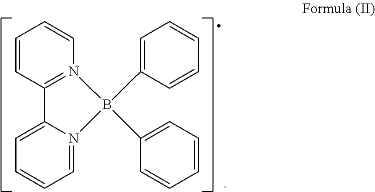

In some embodiments where n is −1, the organoboron compound may comprise a structure of Formula (III):

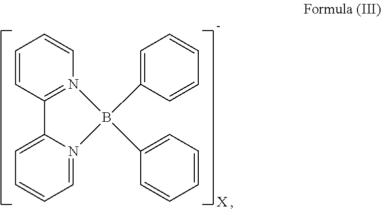

with X being the positive counterion.

The positive counterion may be a cation comprising group I elements such as Li, Na, K, Cs, and the like. In particular, depending on the solvent used upon synthesis, the group I element may be surrounded by and coordinated with the solvent molecules. In an example embodiment where THF was used as the synthetic solvent, the positive counterion may include a group I element being surrounded by and coordinated with THF molecules.

In some particular embodiments, the organoboron compound may comprise a structure of Formula (IIIA) or Formula (IIIB):

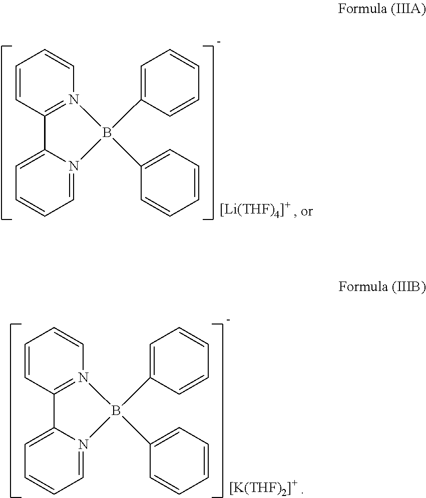

As mentioned, it is believed that the organoboron compounds of the present invention are particularly useful in reductive synthesis. Examples of such a synthesis may comprise any one of metallic lithium (Li(0)) formation, P—P coupling reaction, Sn—Sn coupling reaction, Se—Se coupling reaction, Ge—Ge coupling reaction, H—H coupling reaction, C—C coupling reaction, alkene reduction reaction and CO₂ reduction reaction. Detailed application of the organoboron compounds in the above reductive reaction will be discussed in the later part of the present disclosure.

The method for preparing the organoboron compounds as described herein will now be disclosed. The method may comprise the steps of: (a) providing a first precursor having a structure of Formula (IV):

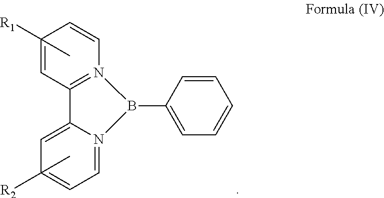

with R₁ and R₂ each being the mono-, di- or tri-substitution as defined herein; and (b) converting the first precursor into the organoboron compound.

In some particular embodiments, the first precursor may have a structure of Formula (IVA):

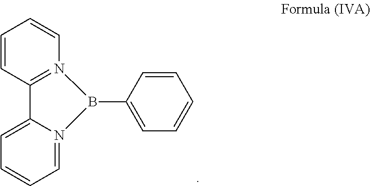

In these particular embodiments, the method may comprise the step of converting the first precursor having the structure of Formula (IVA) into the organoboron compound at room temperature such as from about 20° C. to 40° C.

In some embodiments, the converting step may include stirring a first reaction mixture comprising the first precursor having the structure of Formula (IVA), phenyllithium and THF at room temperature for at least 8 hours to form the organoboron compound having the structure of Formula (II). In particular, the first precursor having the structure of Formula (IVA) and phenyllithium may have a molar ratio of about 1:1.5, such as 1:1.48 . . . 1:1.482 . . . 1:1.486 . . . 1:1.49 . . . 1:1.494 . . . 1:1.5 . . . 1:1.505 . . . 1:1.51 and the like.

In some embodiments, the converting step may include stirring a second reaction mixture comprising the first precursor having the structure of Formula (IVA), phenyllithium and toluene at room temperature for at least 8 hours to form the organoboron compound having the structure of Formula (IIIA). In particular, the first precursor having the structure of Formula (IVA) and phenyllithium may have a molar ratio of about 1:1, such as 1:0.9 . . . 1:0.94 . . . 1:0.96 . . . 1:0.99 . . . 1:1 . . . 1:1.01 . . . 1:1.05 . . . 1:1.1 and the like. In some particular embodiments, the organoboron compound having the structure of Formula (IIIA) may be further converted to the organoboron compound having the structure of Formula (II). This converting step may include stirring a third reaction mixture comprising the organoboron compound having the structure of Formula (IIIA) and toluene at room temperature for at least 8 hours to form the organoboron compound having the structure of Formula (II).

In some embodiments, the converting step may include stirring a fourth reaction mixture comprising the organoboron compound having the structure of Formula (II), potassium and THF at room temperature for at least 8 hours to form the organoboron compound having the structure of Formula (IIIB). In particular, the organoboron compound having the structure of Formula (II) and potassium may have a molar ratio of about 1:2, such as about 1:1.9 . . . 1:1.94 . . . 1:1.96 . . . 1:1.99 . . . 1:2 . . . 1:2.01 . . . 1:2.05 . . . 1:2.1 and the like.

Without wishing to be bound by theory, it is believed that the organoboron compound having the structure of Formula (IIIB) is reversibly convertible to the organoboron compound having the structure of Formula (II). For example, in some embodiments, the organoboron compound having the structure of Formula (IIIB) may be reversibly converted to the organoboron compound having the structure of Formula (II) when the organoboron compound having the structure of Formula (IIIB) is heated in toluene at a temperature of about 70° C. to about 80° C., such as from 68° C. to 82° C., from 68° C. to 81° C., from 69° C. to 82° C., from 70° C. to 82° C., from 71° C. to 80° C., from 70° C. to 78° C., from 72° C. to 82° C., from 72° C. to 76° C., from 73° C. to 76° C. and the like, for at least 8 hours.

Hereinafter, the present invention is described more specifically by way of examples, but the present invention is not limited thereto.

### EXAMPLES

### Materials and Characterization

### Materials

All synthetic experiments and product purifications were conducted using glovebox (Ar) or Schlenk (N₂) techniques (except for preparative thin layer chromatography, PTLC, and column chromatography). Chemicals were purchased from Sigma Aldrich, TCI, Aladdin, Macklin, or Bidepharm and used without further treatment. SPS-purified THF, toluene, and n-hexane were dried using 3 Å molecular sieves in the glovebox. Deuterated solvents (CDCl₃, C₆D₆) were degassed by freeze-pump-thaw cycles and stored over 3 Å molecular sieves in the glovebox (THF-d₈ was dried using NaK before use, and deuterated solvents for air-stable products were used without further treatment). CO₂ (99.99%) was purchased from Linde Industrial Gases and dried with a combination of a P₂O₅ drying column and 3 Å molecular sieves over one week.

The nuclear magnetic resonance (NMR) spectroscopy was facilitated over a Bruker Avance series of spectrometers with frequencies of 300, 400, and 600 MHz. Chemical shifts (δ) are presented in ppm and set relative to the respective solvent's residual proton (¹H) signal or the carbon nuclei (¹³C{¹H})·^{[11] 11}B, ¹¹⁹Sn{¹H}, ³¹P{¹H}NMR spectra were referenced to external standards, BF₃·OEt₂, SnMe₄ and 85% H₃PO₄, respectively. High-resolution mass spectra were recorded via a Sciex X500R Q-TOF mass spectrometer.

Gas products were analyzed by online gas chromatography (GC2060).

Cyclic voltammetry (CV) was tested using CH instruments CHI660 electrochemical workstation. All experiments were carried out under an atmosphere of argon in the three-electrode cell (glassy carbon used as working electrode, platinum wire electrode used as counter electrode, and silver electrode used as reference electrode) with anhydrous THF solution containing 0.1 M [nBu4N][PF6](dried over 3 Å molecular sieves for one week before test). Ferrocene/ferrocenium couple was used as an internal standard.

EPR spectra were acquired on ADANI SPINSCAN X EPR Spectrometer. All samples were prepared and tested under argon conditions. Easyspin (5.2.35) was used to simulate the spectra. Microwave frequency was 9.450400 GHz, and power was 14.581 mW.

Powder XRD Analysis was acquired on Bruker D2 Phaser. The sample was prepared as follows: during the synthesis of [(bipy)BPh₂](6), the insoluble black solids were collected and washed with THF (6 mL) and dried under a fine vacuum as grey powder. Samples were stored in argon and quickly tested in air.

XPS Analysis was acquired on Thermo Scientific K-Alpha. Sample Exp. was prepared as follows: during the synthesis of [(bipy)BPh₂](6), the insoluble black solids were collected and washed with THF (6 mL) and dried under a fine vacuum as grey powder. Sample Cml. was from Sigma-Aldrich 499811-100G, Lithium granular, 99% trace metals basis. Sample Exp.+Cml. was a mixture of Sample Exp. and Sample Cml.

Inductively Coupled Plasma Optical Emission spectroscopy (ICP-OES) was recorded using The OPtima 8000 spectrometer. Detection of Li⁺ is performed as follows: the sample was collected from the reaction as detailed in Example 4B. The insoluble black solids were collected, washed with THF (6 mL), and dried under a fine vacuum as grey powder. Compound 5 (1.5 mg) was quenched with deionized water (1 mL). Detection of K⁺ is performed as follows: the sample was collected form the reaction as detailed in Example 4C. Compound (5′) (35 mg, 0.070 mmol) was suspended in toluene (10 mL) at room temperature. The mixture was heated with or without stirring at 75° C. overnight. The color of the toluene solution turned dark green. After filtration, the toluene solution was collected, and all the volatile was removed under a high vacuum, affording compound 6 (2.3 mg, 10%). The residue was then washed with THF (6 mL). The residue and funnel were quenched with 1 mL of deionized water and washed with 9 mL of deionized water. (collected 10 mL in total).

All the computational calculations were carried out using ORCA (version 5.0.4). Geometry optimization was performed at the density functional theory (DFT) using M062X with a def2-TZVP basis set. Counterions were omitted during calculations. The THF solution was modeled by the Conductor-like Polarizable Continuum Model (CPCM) in optimization. Harmonic vibrational analyses were carried out to confirm if the optimized structure was a local minimum structure and to provide zero-point vibrational energy corrections and thermal corrections to various thermodynamic properties. Magnetic properties were calculated using revTPSS [13]/pcSseg-1 level of theory with optimized structures with the SMD solvent model. ACID was calculated from AICD2.0 software.

Naphthalene anion was used as a reducing agent in the control experiments of the P—P, Sn—Sn, Se—Se, and Ge—Ge coupling reactions, and of the reductive coupling of pyridine and Birch reduction of Acridine. In these control experiments, sodium naphthalene was freshly prepared from a mixture of naphthalene and sodium in THF at −35° C. (concentration was 0.1 mol/L).

For control experiment of P—P coupling reactions, to the C₆D₆ solution of Ph₂PCl (4.4 mg, 0.02 mmol, 1.0 eq.) in J. Young's tube was added 200 μL 0.1M sodium naphthalene (0.02 mmol, 1.0 eq.). The reaction was placed at room temperature overnight, and subjected to ³¹P NMR analysis afterwards.

For control experiment of Sn—Sn coupling reactions, to the C₆D₆ solution of nBu3SnC1 (6.5 mg, 0.02 mmol, 1.0 eq.) in J. Young's tube was added 200 μL 0.1M sodium naphthalene (0.02 mmol, 1.0 eq.). The reaction was placed at room temperature overnight, and subjected to ¹H NMR analysis afterwards.

For control experiment of Se—Se coupling reactions, to the C₆D₆ solution of PhSeCl (3.8 mg, 0.02 mmol, 1.0 eq.) in J. Young's tube was added 200 μL 0.1M sodium naphthalene (0.02 mmol, 1.0 eq.). The reaction was placed at room temperature overnight, and subjected to ¹H NMR analysis afterwards.

For control experiment of Ge—Ge coupling reactions, to the C₆D₆ solution of Et₃GeCl (3.9 mg, 0.02 mmol, 1.0 eq.) in J. Young's tube was added 200 μL 0.1M sodium naphthalene (0.02 mmol, 1.0 eq.). The reaction was placed at room temperature overnight, and subjected to ¹H NMR analysis afterwards.

For control experiment of reductive pyridine coupling, to 0.1M Sodium naphthalene (0.63 mmol, 1.0 eq.), pyridine (50 mg, 0.63 mmol, 1.0 eq.) was added. After stirring at room temperature overnight, drops of MeOH were added to quench the reaction. The reaction mixture was then subjected to TLC analysis (EA:DCM=2:1, 1% NEt₃).

For control experiment of reduction of acridine, to 0.1M sodium naphthalene (0.28 mmol, 1.0 eq.), acridine (50 mg, 0.28 mmol, 1.0 eq.) was added. After stirring at room temperature overnight, drops of MeOH were added to quench the reaction. The reaction mixture was then subjected to TLC analysis (EA:Hex=1:5).

### Example 1

### Synthesis of (bipy)BPh (4) (Formula (IVA))

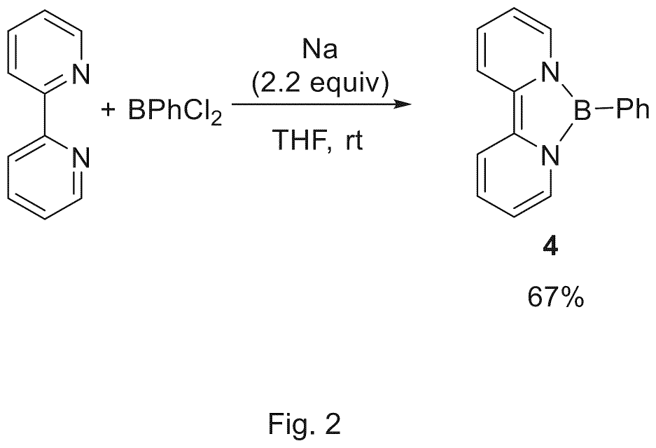

The synthetic scheme of (bipy)BPh (4) is illustrated in FIG. 2. Specifically, to a solution of 2,2′-bipyridine (1075 mg, 6.89 mmol, 1.0 eq.) in THF (20 mL) was added BPhCl₂ (1096 mg, 6.89 mmol, 1.0 eq.). The mixture was stirred at room temperature for 5 min. Then, sodium (348 mg, 15.13 mmol, 2.2 eq.) was added to the reaction mixture at room temperature, and the reaction was stirred at room temperature overnight. Afterward, all the volatile was removed under a high vacuum, and toluene (50 mL) was added to extract the target product. After filtration, the toluene phase was reduced under high vacuum, affording compound 4 as a red solid (1132 mg, 67%). Compound 4 was pure at this stage, and no further purification was needed.

¹H NMR (400 MHz, C₆D₆, 298K): δ [ppm]=7.64 (d, J_{H-H}=7.2 Hz, 2H), 7.49 (d, J_{H-H}=6.1 Hz, 2H), 7.31-7.23 (m, 3H), 7.19 (d, J_{H-H}=9.1 Hz, 2H), 6.18 (dd, J_{H-H}=9.3, 6.0 Hz, 2H), 5.92 (t, J_{H-H}=6.6 Hz, 2H). ¹¹B NMR (128 MHz, C₆D₆, 298K): δ [ppm]=21.56. ¹³C{¹H}NMR (100 MHz, C₆D₆, 298K): δ [ppm]=133.84, 129.33, 128.71, 127.25, 118.99, 118.55, 114.77, 110.93. HRMS (m/z): Calc. For [4](C₁₆H₁₃BN₂): 244.1172 Found: 244.1169.

### Example 2

### Synthesis of [Li(THF)₄][(bipy)BPh₂](5) (Formula (IIIA))

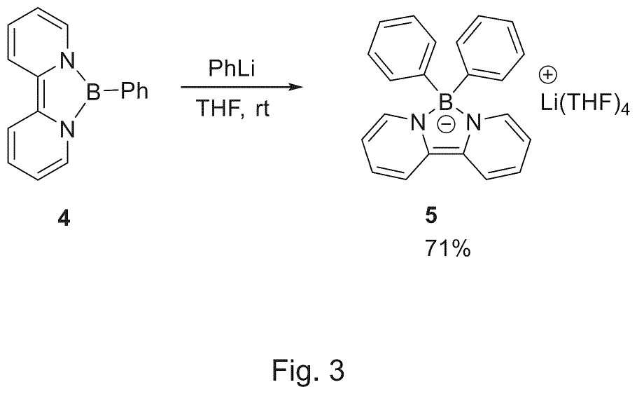

The synthetic scheme of [Li(THF)₄][(bipy)BPh₂] is illustrated in FIG. 3. Specifically, to a solution of compound 4 (300 mg, 1.23 mmol, 1.0 eq.) in THF (10 mL) was added PhLi (103 mg, 1.23 mmol, 1.0 eq.) at room temperature. The reaction mixture was stirred at room temperature overnight. Afterward, the mixture was filtered. The filtrate was collected and reduced under a high vacuum, affording 5 as a black solid (540 mg, 71%).

Single crystals suitable for X-ray crystal structure analysis were obtained from vapor diffusion of n-hexane to THF solution at room temperature.

¹H NMR (400 MHz, THF-d₈, 298K): δ [ppm]=7.42 (d, J_{H-H}=7.3 Hz, 4H), 7.03 (t, J_{H-H}=7.3 Hz, 4H), 6.88 (t, J_{H-H}=7.3 Hz, 2H), 5.68 (d, J_{H-H}=6.7 Hz, 2H), 5.11 (d, J_{H-H}=9.4 Hz, 2H), 4.64 (dd, J_{H-H}=9.5, 5.3 Hz, 2H), 3.82 (t, J_{H-H}=6.1 Hz, 2H).

¹¹B NMR (128 MHz, THF-d₈, 298K): δ [ppm]=2.79. ¹³C{¹H}NMR (100 MHz, THF-d₈, 298K): δ [ppm]=140.43, 133.96, 126.66, 124.27, 119.68, 117.64, 116.24, 94.50. HRMS (m/z): Calc. For [5-Li(THF)₄](C₂₂H₁₈BN₂): 321.1563 Found: 321.1548

### Example 3

### Synthesis of [K(THF)₂][(bipy)BPh₂](5′) (Formula (IIIB))

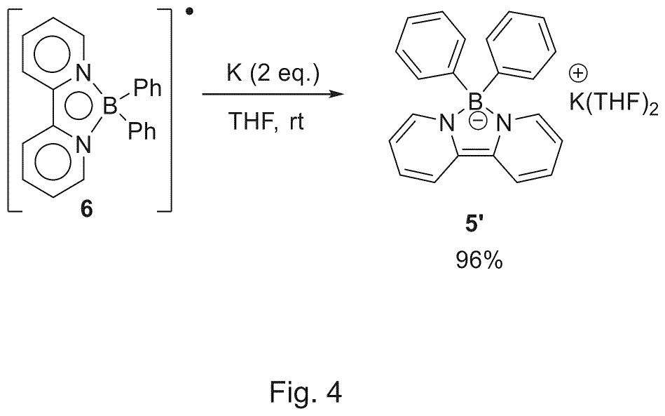

The synthetic scheme of [K(THF)₂][(bipy)BPh₂](5′) illustrated in FIG. 4. Specifically, to a solution of compound 6 ([(bipy)BPh₂]) (367 mg, 1.14 mmol, 1.0 eq.) in THF (10 mL) was added potassium (89 mg, 2.28 mmol, 2.0 eq.) at room temperature. The reaction mixture was stirred at room temperature overnight. Afterward, the mixture was filtered. The filtrate was collected and reduced under a high vacuum, affording compound 5′ as a black solid (552 mg, 96%).

¹H NMR (400 MHz, THF-d₈, 298K): δ [ppm]=7.42 (d, J_{H-H}=7.2 Hz, 4H), 7.09 (t, J_{H-H}=7.3 Hz, 4H), 6.95 (t, J_{H-H}=7.3 Hz, 2H), 5.70 (d, J_{H-H}=6.8 Hz, 2H), 5.20 (d, J_{H-H}=9.5 Hz, 2H), 4.73 (dd, J_{H-H}=9.5, 5.3 Hz, 2H), 3.93 (t, J_{H-H}=6.1 Hz, 2H). ¹¹B NMR (128 MHz, THF-d₈, 298K): δ [ppm]=2.73. ¹³C{¹H}NMR (100 MHz, THF-d₈, 298K): δ [ppm]=139.66, 133.32, 126.97, 124.75, 118.84, 117.29, 116.54, 95.25. HRMS (m/z): Calc. For [5′-K(THF)₂](C₂₂H₁₈BN₂): 321.1563 Found: 321.1555.

### Example 4A

### Synthesis of [(bipy)BPh₂](6) from (bipy)BPh (4)

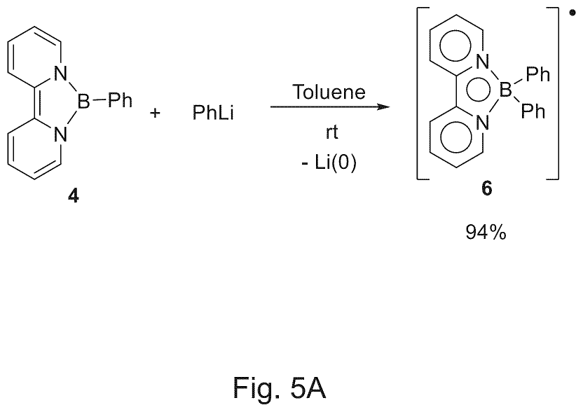

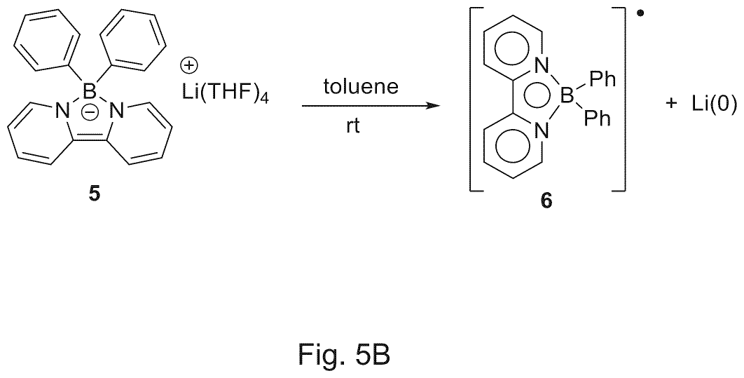

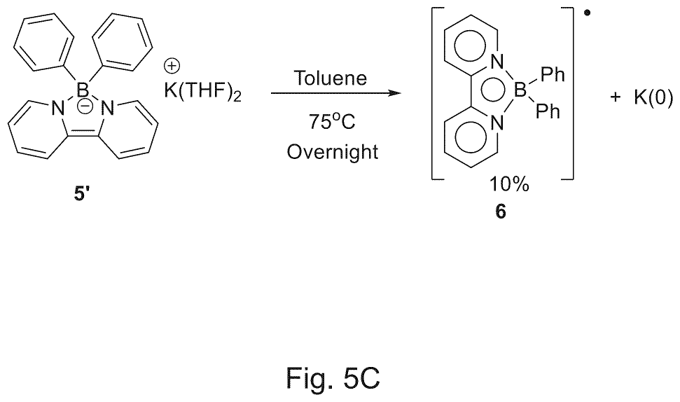

The synthetic scheme is illustrated in FIG. 5A. Specifically, to a solution of 4 (210 mg, 0.86 mmol, 1.0 eq.) in toluene (10 mL) was added PhLi (108 mg, 1.29 mmol, 1.5 eq.) at room temperature. The reaction mixture was stirred at room temperature overnight. Afterward, the mixture was filtered. The filtrate was collected and reduced under a high vacuum, affording compound 6 as a deep green solid (260 mg, 94%).

Single crystals suitable for X-ray crystal structure analysis were obtained from the slow evaporation of a toluene solution at room temperature or recrystallization at −35° C. in THF. ¹H NMR (400 MHz, C₆D₆, 298K): silence. ¹¹B NMR (128 MHz, C₆D₆, 298K): silence. g-factor (toluene, 298K): 2.0036. HRMS (m/z): Calc. For 6 (C₂₂H₁₈BN₂): 321.1563 Found: 321.1552.

### Example 4B

### Synthesis of [(bipy)BPh₂](6) from [Li(THF)₄][(bipy)BPh₂](5)

The synthetic scheme is illustrated in FIG. 5B. Specifically, toluene (10 mL) was added to 5 (255 mg, 0.41 mmol) in the glovebox and stirred at room temperature overnight. Afterward, the mixture was filtered. The filtrate was collected and reduced under a high vacuum, affording compound 6 as deep green powder. (113 mg, 85%)

Single crystals suitable for X-ray crystal structure analysis were obtained from the slow evaporation of a toluene solution at room temperature or recrystallization at −35° C. in THF. ¹H NMR (400 MHz, C₆D₆, 298K): silence. ¹¹B NMR (128 MHz, C₆D₆, 298K): silence. g-factor (toluene, 298K): 2.0036. HRMS (m/z): Calc. For [6](C₂₂H₁₈BN₂): 321.1563 Found: 321.1552.

### Example 4C

### Synthesis of [(bipy)BPh₂](6) from [K(THF)₂][(bipy)BPh₂](5′)

The synthetic scheme is illustrated in FIG. 5C. Specifically, compound 5′ (35 mg, 0.070 mmol) was suspended in toluene (10 mL) at room temperature. The mixture was heated with or without stirring at 75° C. overnight. The color of the toluene solution turned dark green. After filtration, the toluene solution was collected, and all the volatile was removed under a high vacuum, affording compound 6 (2.3 mg, 10%).

Single crystals suitable for X-ray crystal structure analysis were obtained from the slow evaporation of a toluene solution at room temperature or recrystallization at −35° C. in THF. ¹H NMR (400 MHz, C₆D₆, 298K): silence. ¹¹B NMR (128 MHz, C₆D₆, 298K): silence. g-factor (toluene, 298K): 2.0036. HRMS (m/z): Calc. For 6 (C₂₂H₁₈BN₂): 321.1563 Found: 321.1552.

### Example 5

### Control Experiment

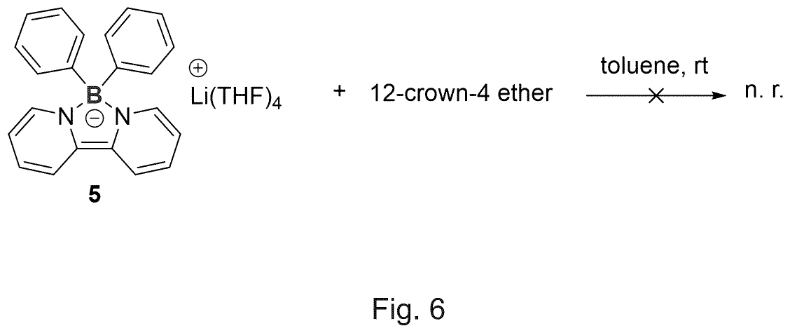

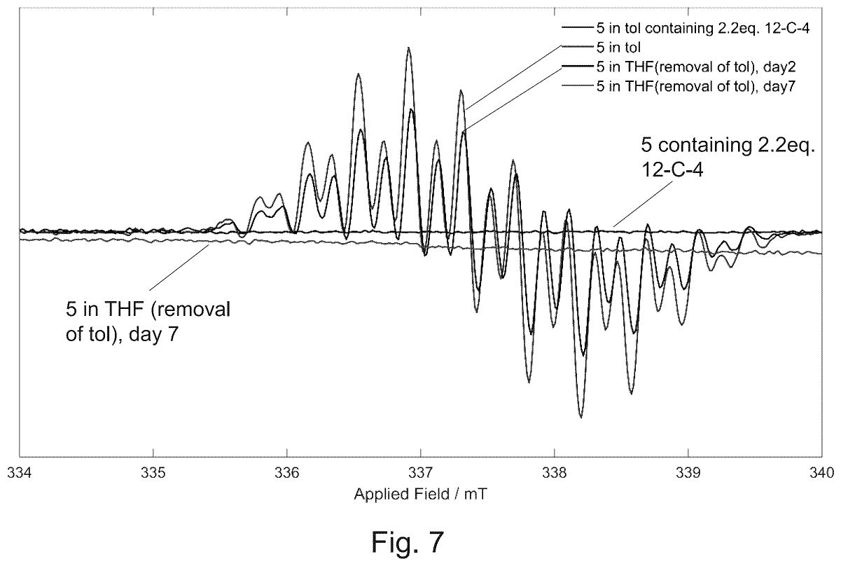

12-crown-4 ether (6 mg, 0.035 mmol, 2.2 eq.) was solved in toluene (1 mL) and added to compound 5 (10 mg, 0.016 mmol) in a J. Young's tube (FIG. 6). The solution was slightly red, and many black powders remained insoluble. The solution was EPR silence. (FIG. 7)

### Example 6A

### Synthesis of [(bipy)BPh₂][CuCl₂](7) from [K(THF)₂][(bipy)BPh₂](5′)

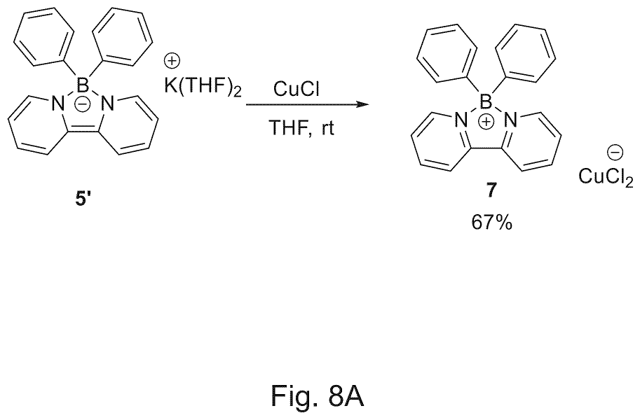

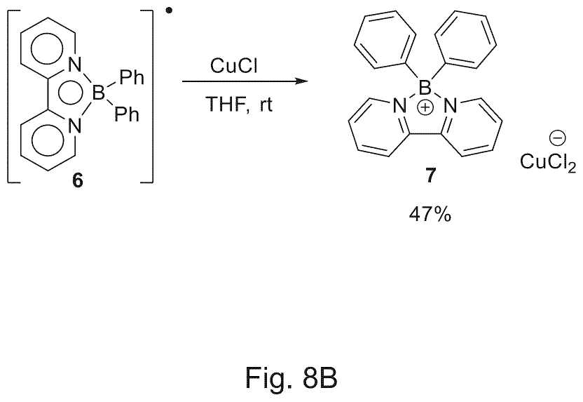

The synthetic scheme is illustrated in FIG. 8A. Specifically, To THF solution (10 mL) of 5′ (297 mg, 0.59 mmol, 1.0 eq.) was added CuCl (175 mg, 1.77 mmol, 3.0 eq.). The reaction mixture was stirred at room temperature overnight. Afterward, the solution was concentrated to about 2 mL, and n-hexane (5 mL) was added. Red solids precipitated after storage at −35° C. overnight. After filtration, the solids were dried over high vacuum, affording compound 7 (180 mg, 67%).

Single crystals suitable for X-ray crystal structure analysis were obtained from recrystallization at −35° C. in the mixture solvent of DCM/n-hexane/THF. ¹H NMR (600 MHz, CDCl₃, 298K): δ [ppm]=9.51 (d, J_{H-H}=8.1 Hz, 2H), 8.79 (t, J_{H-H}=8.0 Hz, 2H), 8.64 (d, J_{H-H}=5.7 Hz, 2H), 8.02 (t, J_{H-H}=6.8 Hz, 2H), 7.38-7.31 (m, 6H), 7.13 (d, J_{H-H}=7.0 Hz, 4H). ¹¹B NMR (128 MHz, CDCl₃, 298K): δ [ppm]=9.75. ¹³C{¹H}NMR (150 MHz, CDCl₃, 298K): δ [ppm]=145.68, 143.40, 132.69, 129.33, 129.10, 128.91, 125.24. HRMS (m/z): Calc. For [7-CuCl₂](C₂₂H₁₈BN₂): 321.1563 Found: 321.1557.

### Example 6B

### Synthesis of [(bipy)BPh₂][CuCl₂](7) from [(bipy)BPh₂](6)

The synthetic scheme is illustrated in FIG. 8B. Specifically, to THF solution (4 mL) of 6 (50 mg, 0.15 mmol, 1.0 eq.) was added CuCl (154 mg, 1.55 mmol, 10 eq.). The reaction was stirred at room temperature overnight. Then, excess CuCl was removed via filtration. All the volatile was removed under a fine vacuum, and 7 was obtained as a red powder (33 mg, 47%).

Single crystals suitable for X-ray crystal structure analysis were obtained from recrystallization at −35° C. in the mixture solvent of DCM/n-hexane/THF. ¹H NMR (600 MHz, CDCl₃, 298K): δ [ppm]=9.51 (d, J_{H-H}=8.1 Hz, 2H), 8.79 (t, J_{H-H}=8.0 Hz, 2H), 8.64 (d, J_{H-H}=5.7 Hz, 2H), 8.02 (t, J_{H-H}=6.8 Hz, 2H), 7.38-7.31 (m, 6H), 7.13 (d, J_{H-H}=7.0 Hz, 4H). ¹¹B NMR (128 MHz, CDCl₃, 298K): δ [ppm]=9.75. ¹³C{¹H}NMR (150 MHz, CDCl₃, 298K): δ [ppm]=145.68, 143.40, 132.69, 129.33, 129.10, 128.91, 125.24. HRMS (m/z): Calc. For [7-CuCl₂](C₂₂H₁₈BN₂): 321.1563 Found: 321.1557.

### Example 7A

### P—P Coupling Reaction from [K(THF)₂][(bipy)BPh₂](5′)

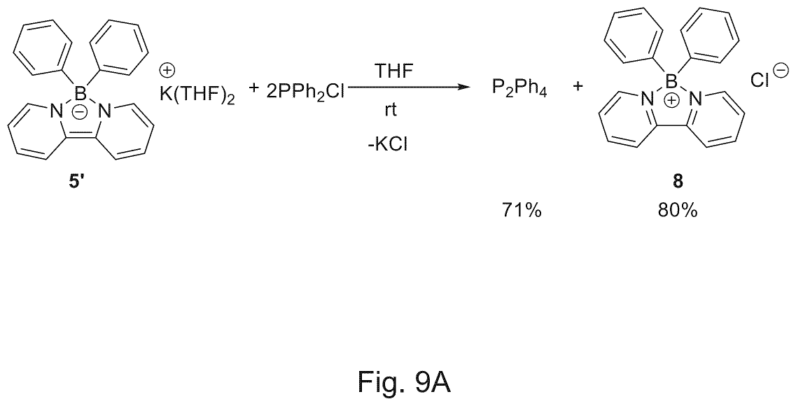

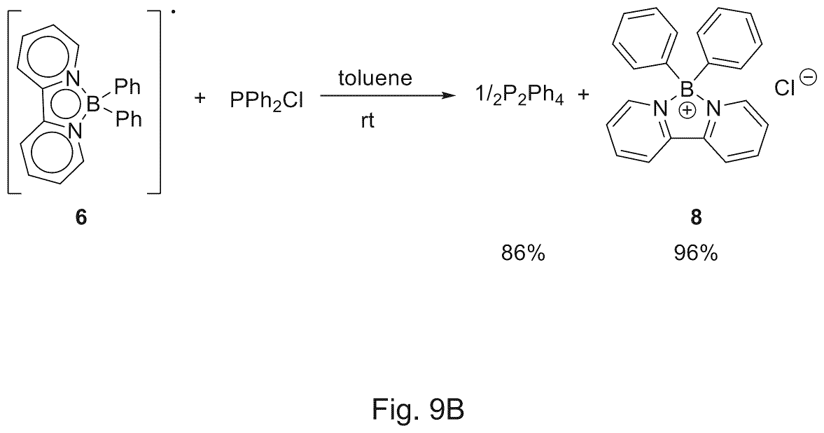

The reaction scheme is illustrated in FIG. 9A. Specifically, to the THF solution (5 mL) of 5′ (100 mg, 0.20 mmol, 1.0 eq.) was added PPh₂Cl (90 mg, 0.40 mmol, 2.0 eq.). The reaction was stirred at room temperature overnight, and all the volatile was removed under a high vacuum afterward. The residue was extracted by n-hexane (2×6 mL). P₂Ph₄ was in the hexane solution and obtained after being dried under a high vacuum, giving a yellow powder (54 mg, 71%). The residue was dried under high vacuum as 8 (59 mg, 80%).

P₂Ph₄: ¹H NMR (400 MHz, C₆D₆, 298K): δ [ppm]=7.58-7.52 (m, 4H), 6.97-6.91 (m, 6H). ³¹P{¹H}NMR (161 MHz, C₆D₆, 298K): δ [ppm]=−15.01. [8]: ¹H NMR (400 MHz, CDCl₃, 298K): δ [ppm]=10.72 (d, J_{H-H}=8.3 Hz, 2H), 8.71 (t, J_{H-H}=8.1 Hz, 2H), 8.57 (d, J_{H-H}=5.6 Hz, 2H), 7.95 (t, J_{H-H}=6.8 Hz, 2H), 7.40-7.29 (m, 6H), 7.08 (d, J_{H-H}=7.0 Hz, 4H). ¹¹B NMR (128 MHz, CDCl₃, 298K): δ [ppm]=9.16 ¹³C{¹H}NMR (100 MHz, CDCl₃, 298K): δ [ppm]=145.70, 142.63, 132.55, 129.10, 128.94, 128.64, 127.30.

### Example 7B

### P—P Coupling Reaction from [(bipy)BPh₂](6)

The reaction scheme is illustrated in FIG. 9B. Specifically, to the toluene solution (5 mL) of 6 (50 mg, 0.16 mmol, 1.0 eq.) was added PPh₂Cl (35 mg, 0.16 mmol, 1.0 eq.). The reaction was stirred at room temperature overnight. All the volatile was removed under a high vacuum afterward. The residue was extracted by n-hexane (3×3 mL). P₂Ph₄ was in the hexane solution and obtained after being dried under a high vacuum, giving a yellow powder (25 mg, 86%). The residue was dried under high vacuum as 8 (55 mg, 96%).

P₂Ph₄: ¹H NMR (400 MHz, C₆D₆, 298K): δ [ppm]=7.58-7.52 (m, 4H), 6.97-6.91 (m, 6H). ³¹P{¹H}NMR (161 MHz, C₆D₆, 298K): δ [ppm]=−15.01. 8: ¹H NMR (400 MHz, CDCl₃, 298K): δ [ppm]=10.72 (d, J_{H-H}=8.3 Hz, 2H), 8.71 (t, J_{H-H}=8.1 Hz, 2H), 8.57 (d, J_{H-H}=5.6 Hz, 2H), 7.95 (t, J_{H-H}=6.8 Hz, 2H), 7.40-7.29 (m, 6H), 7.08 (d, J_{H-H}=7.0 Hz, 4H). ¹¹B NMR (128 MHz, CDCl₃, 298K): δ [ppm]=9.16 ¹³C{¹H}NMR (100 MHz, CDCl₃, 298K): δ [ppm]=145.70, 142.63, 132.55, 129.10, 128.94, 128.64, 127.30.

### Example 8

### Sn—Sn Coupling Reaction

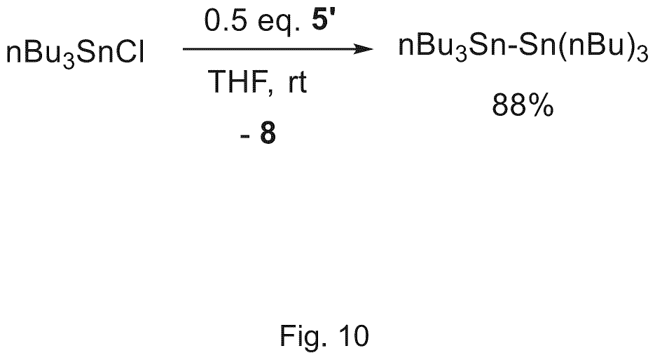

The reaction scheme is illustrated in FIG. 10. Specifically, to the THF solution (3 mL) of 5′ (50 mg, 0.10 mmol, 1 eq.) was added nBu₃SnC1 (64 mg, 0.20 mmol, 2.0 eq.). The reaction was stirred at room temperature overnight, and all the volatile was removed under a high vacuum afterward. The residue was extracted by n-hexane, and n-Bu₆Sn₂ was obtained after removing all the volatiles under a high vacuum (50 mg, 88%).

NBu₆Sn₂: ¹H NMR (400 MHz, C₆D₆, 298K): δ [ppm]=1.80-1.58 (m, 12H), 1.47-1.36 (m, 12H), 1.26-1.07 (m, 12H), 0.98 (t, J_{H-H}=7.3 Hz, 18H). ¹³C{¹H}NMR (100 MHz, C₆D₆, 298K): δ [ppm]=29.87, 27.74, 13.78, 10.23. ¹¹⁹Sn{¹H}NMR (149 MHz, C₆D₆, 298K): δ [ppm]=−83.72.

### Example 9

### Se—Se Coupling Reaction

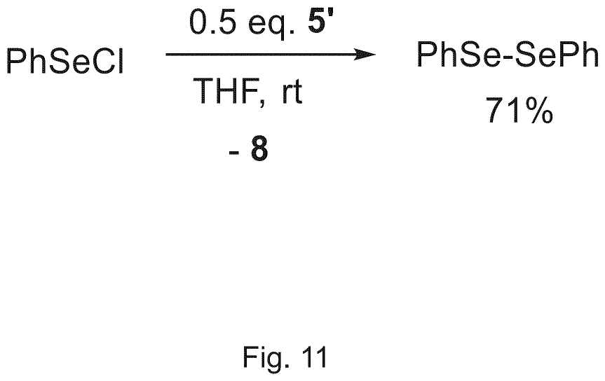

The reaction scheme is illustrated in FIG. 11. Specifically, PhSeCl (38 mg, 0.20 mmol, 2.0 eq.) was added to the THF solution (3 mL) of 5′ (50 mg, 0.10 mmol, 1.0 eq.). The reaction was stirred at room temperature overnight, and all the volatile was removed under a high vacuum afterward. Ph₂Se₂ was successfully isolated using PTLC (n-hexane) and obtained as a yellow powder (22 mg, 71%).

Ph₂Se₂: ¹H NMR (400 MHz, CDCl₃, 298K): δ [ppm]=7.66-7.57 (m, 4H), 7.34-7.21 (m, 6H).

### Example 10

### Ge—Ge Coupling Reaction

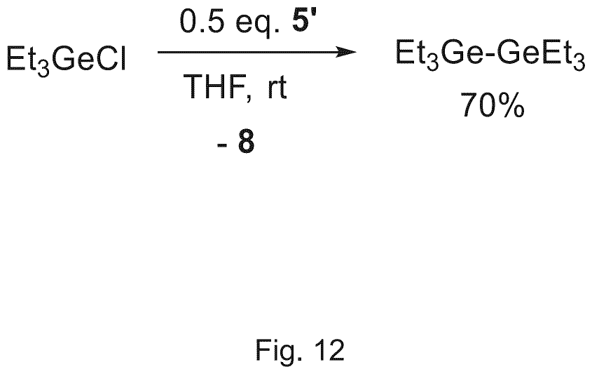

The reaction scheme is illustrated in FIG. 12. Specifically, a THF solution (1 mL) of Et₃GeCl (38 mg, 0.20 mmol, 2.0 eq.) was added to 5′ (50 mg, 0.10 mmol, 1.0 eq.) in THF (3 mL). The reaction was stirred at room temperature overnight, and all the volatile was removed under a high vacuum afterward. Et₆Ge₂ was purified through column chromatography using n-hexane as an eluent and obtained as a colorless oil (11 mg, 70%).

Et₆Ge₂: ¹H NMR (400 MHz, CDCl₃, 298K): δ [ppm]=1.05 (t, J_{H-H}=7.7 Hz, 18H), 0.86 (q, J_{H-H}=7.6 Hz, 12H). ¹³C{¹H}NMR (100 MHz, CDCl₃, 298K): δ [ppm]=10.08, 5.44.

### Example 11

### H—H Coupling Reaction

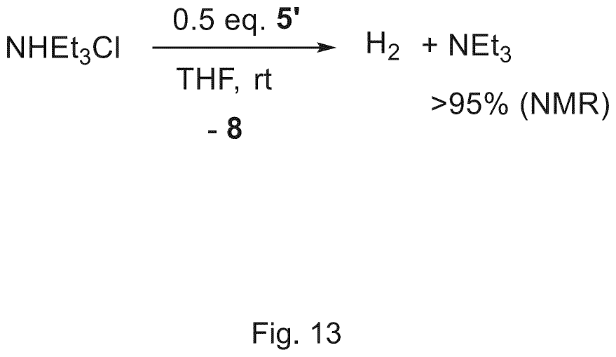

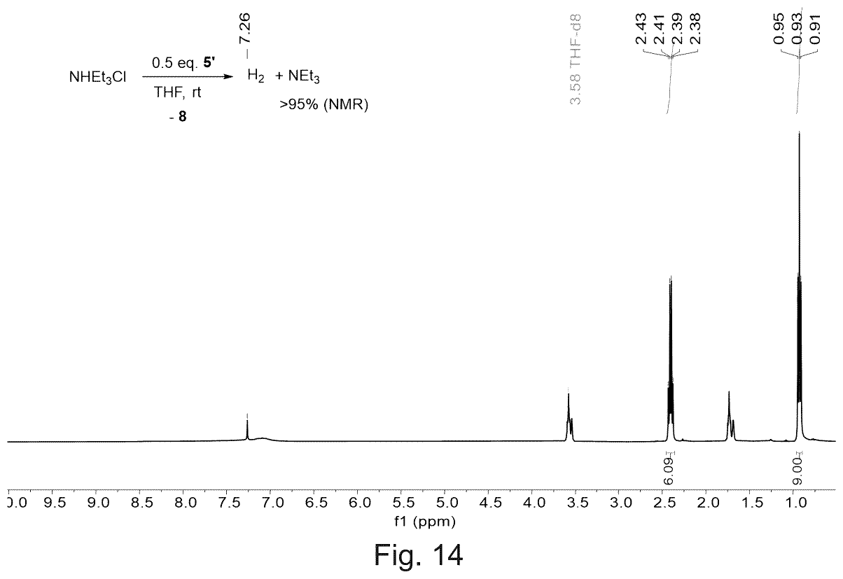

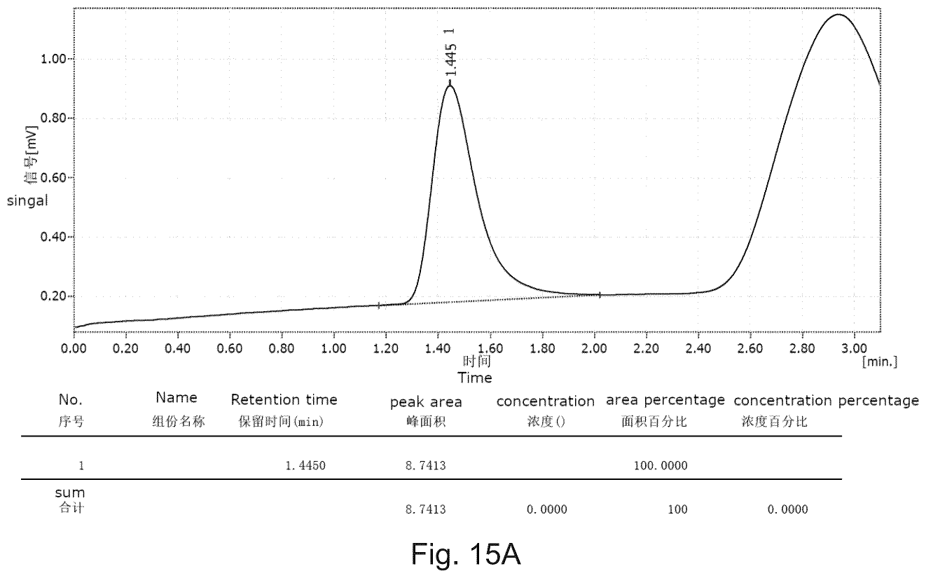

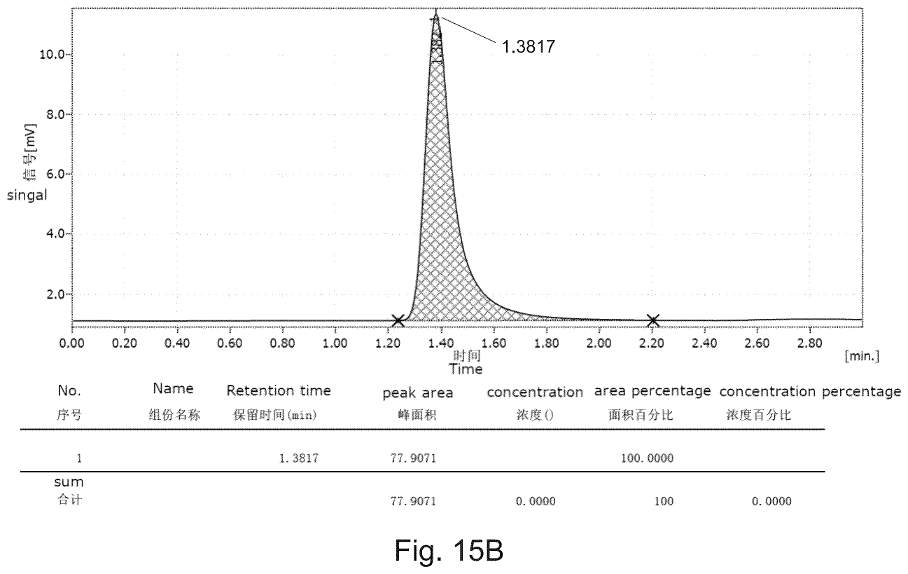

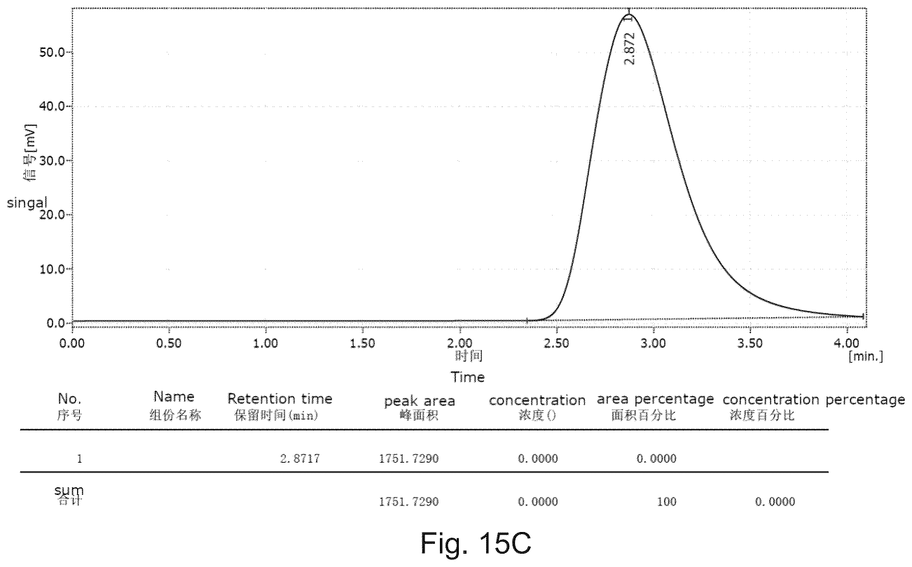

The reaction scheme is illustrated in FIG. 13. Specifically, compound 5′ (50 mg, 0.10 mmol, 1.0 eq.) and NHEt₃C1 (27 mg, 0.20 mmol, 2.0 eq.) were mixed in THF-d₈ (0.55 mL) at room temperature. After 12 hours, the clean generation of NEt₃ was observed in ¹H NMR (FIG. 14), and the formation of H₂ was confirmed by GC spectra (FIGS. 15A-15C).

### Example 12

### Reductive Pyridine Coupling

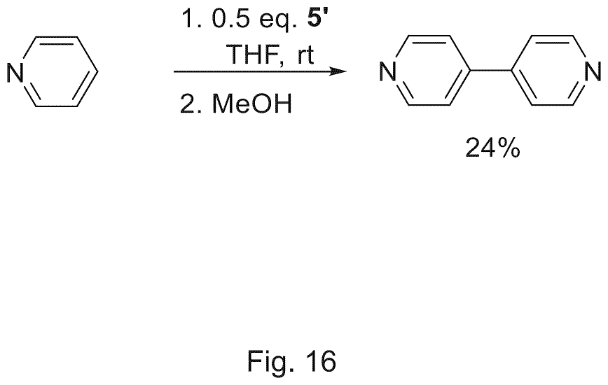

The reaction scheme is illustrated in FIG. 16. Specifically, To the THF solution (3 mL) of 5′ (100 mg, 0.20 mmol, 1.0 eq.) was added pyridine (32 mg, 0.40 mmol, 2.0 eq.). The reaction was stirred at room temperature for 5 days or 60° C. overnight. Drops of MeOH were added to quench the reaction. 4,4′-bipyridine was isolated using PTLC (EA:DCM=2:1, 1% NEt₃) and obtained as a yellow powder (7.6 mg, 24%). 4,4′-bipyridine: ¹H NMR (400 MHz, CDCl₃, 298K): δ [ppm]=8.74 (dd, J_{H-H}=1.7 Hz, 4H), 7.53 (dd, J_{H-H}=1.7 Hz, 4H).

### Example 13

### Reduction of Acridine

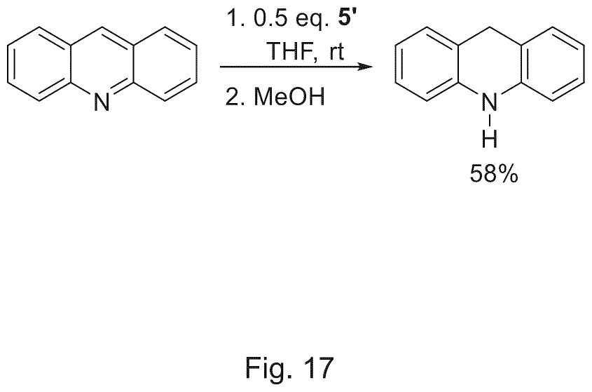

The reaction scheme is illustrated in FIG. 17. Specifically, to the solid mixture of 5′ (50 mg, 0.10 mmol, 1.0 eq.) and acridine (36 mg, 0.20 mmol, 2.0 eq.) was added THF (5 mL). The reaction was stirred at room temperature overnight. Drops of MeOH were added to quench the reaction. Acridan was isolated using PTLC (EA:hex=1:5) and obtained as a white powder (21 mg, 58%).

Acridan: ¹H NMR (400 MHz, CDCl₃, 298K): δ [ppm]=7.12-7.05 (m, 4H), 6.85 (td, J_{H-H}=7.4 Hz, 1.2 Hz, 2H), 6.67 (dd, J_{H-H}=7.8 Hz, 1.2 Hz, 2H), 5.96 (s, 1H), 4.06 (s, 2H).

### Example 14A

### CO₂ Reduction

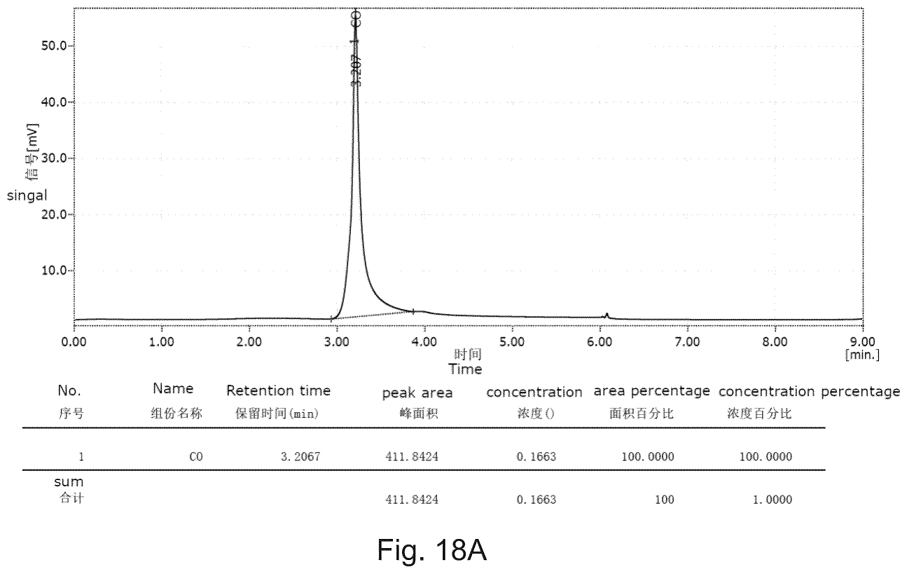

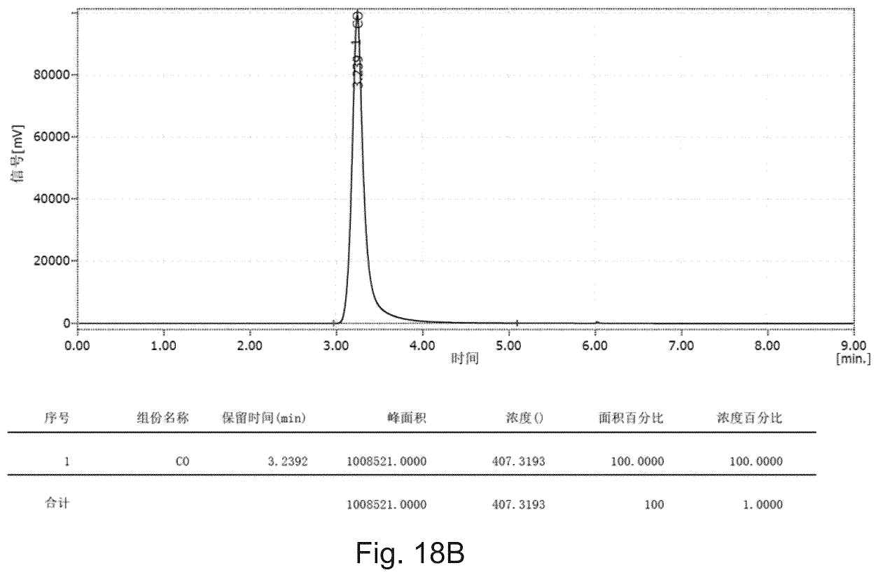

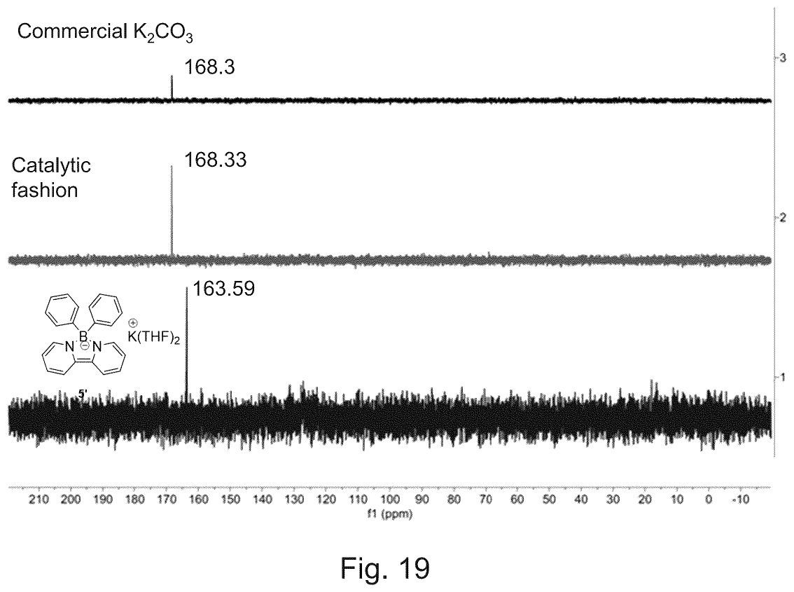

The THF solution (10 mL) of 5′ (50 mg, 0.10 mmol) was degassed in a 250 mL Schlenk tube. An atmosphere of CO₂ was then introduced to the reaction mixture. The reaction was stirred at room temperature overnight. A lot of insoluble solids precipitated. The generation of CO was confirmed by in-situ GC-spectra (FIGS. 18A and 18B). The solids were filtered and washed with THF (1 mL, thrice). The solids were soluble in D₂O. ¹³C{¹H}NMR (100 MHz, D₂O, 298K) spectroscopy was subsequently deployed, where a signal at δ (ppm)=163.59 was detected (FIG. 19). However, this signal disappeared after the addition of an excess of HCl (2M in dioxane).

### Example 14B

### CO₂ Reduction in a Catalytic Fashion

The THF solution (10 mL) of 5′ (39 mg, 0.077 mmol, 1.0 eq.) and K (122 mg, 3.12 mmol, 40 eq.) was degassed in a 100 mL Schlenk tube. A controlled CO₂ atmosphere at 1 atm was introduced (100 mL, about 4 mmol). After being stirred at room temperature for three days, the solution underwent a transformation whereby the potassium was no longer visible, and a lot of insoluble solids precipitated. All the volatiles were reduced from the setup, and the resultant organic products were meticulously rinsed using acetone. After removing the acetone, K₂CO₃ was obtained as a grey powder (152 mg, 70%). ¹³C{¹H}NMR (100 MHz, D₂O, 298K): δ [ppm]=168.33.

### Example 15

### Synthesis, Characterization, and Reactivity of Borate Anion

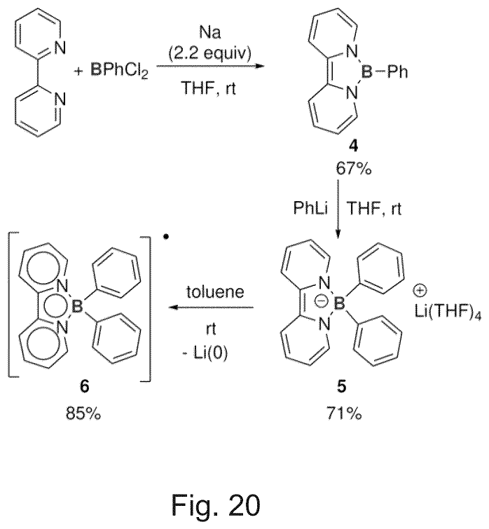

The borate anion 5 was synthesized through the direct reaction of PhLi and an organoboron species 4 (FIG. 20), the synthesis of which can be achieved through a one-pot fashion in 67% isolated yield on a gram scale.

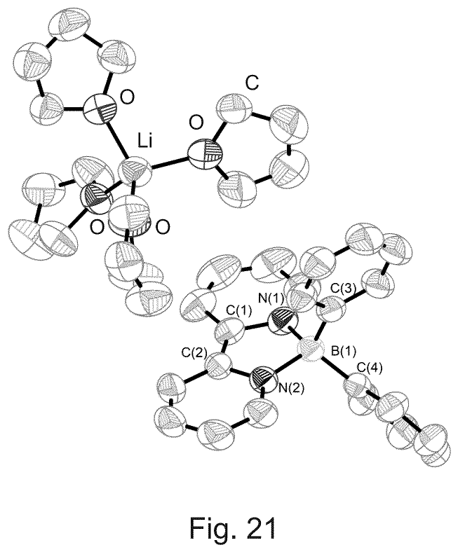

In the ¹¹B NMR spectra, 5 exhibits a signal at 2.79 ppm, in agreement with the presence of a tetracoordinate boron center. The ¹H NMR spectra show four signals at 3.82, 4.64, 5.11, and 5.68 ppm, attributed to the protons from the bipyridine rings, indicating the dearomatization of bipyridine moieties in 5. The identity of 5 was unambiguously confirmed by X-ray single-crystal studies. The lithium cation was coordinated with four THF molecules in the solid state (FIG. 21, upper left). The bipyridine is believed to be in reduced form at the coordination sphere of early transition metals.

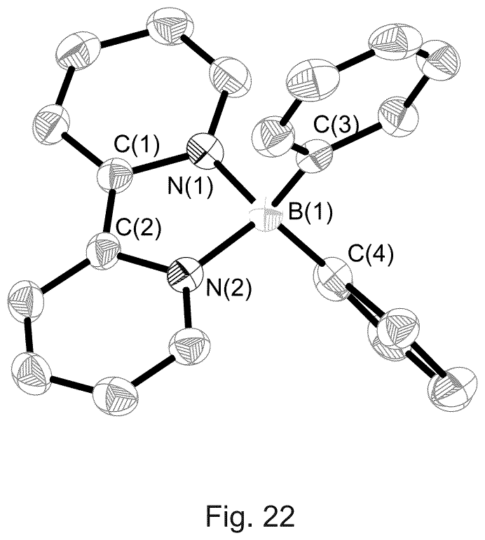

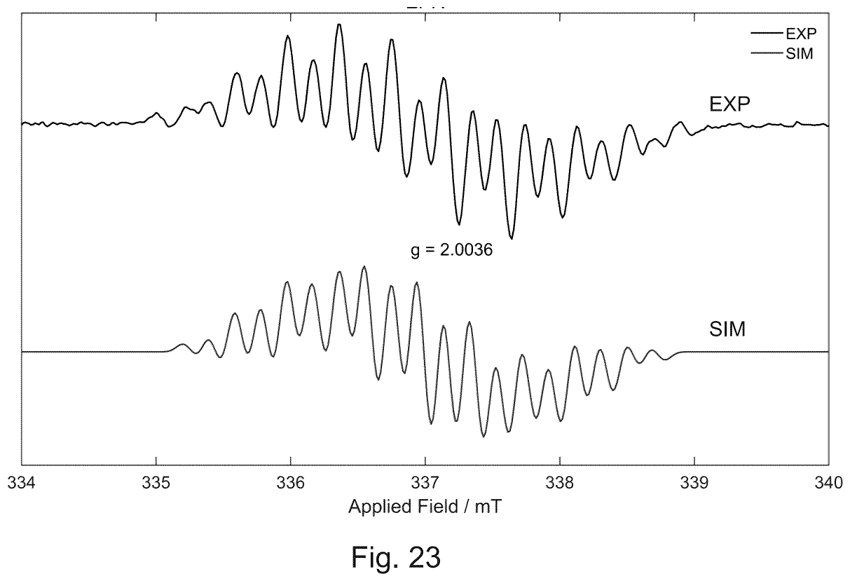

The borate anion 5 was stable in the THF solution. When the solvent was changed to toluene, 5 was gradually converted to an NMR silent species 6 and a black/dark green precipitate. Compound 6 was isolated in 85% yields (FIG. 20) and characterized by single-crystal X-ray analyses, revealing the presence of a tetra-coordinated boron center similar to borate anion 5 (FIG. 22). Since compound 6 is a neutral species, it is believed that it is a radical species. The radical 6 was further analyzed by EPR spectra in a toluene solution at room temperature. An EPR signal (centered at gᵢₛₒ=2.0036) was observed (FIG. 23). The experimental data were then compared with the simulated one, and the hyperfine splitting (a(¹⁰B, 19.9%)=0.05 G, a(¹¹B, 80.1%)=0.16 G, a(¹⁴N)=3.57 G, a(¹H)=1.01, 7.77, 8.89, 10.77 G) suggests that the spin density is mainly delocalized in the bipyridine and BN₂C₂ rings.

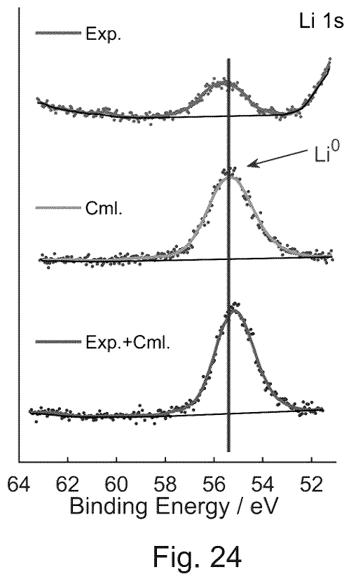

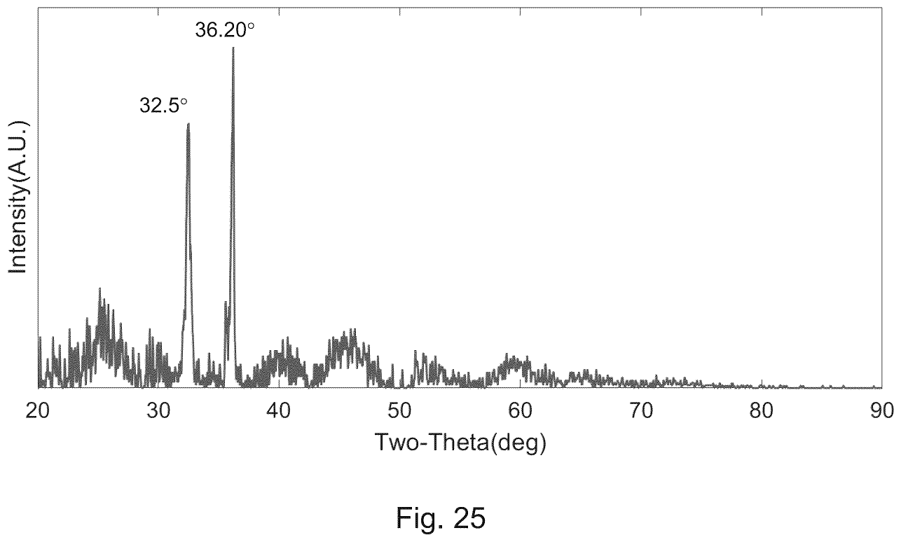

Besides, attempts have been made to identify the lithium-containing species in the product during the formation of radical 6. Since compound 6 was isolated in a high yield (85%), and no other side products were traced by NMR spectra, it is believed that lithium cations might be converted into Li(0) species. To verify this, the black precipitate generated from the reaction was collected, and the X-ray photoelectron spectroscopy (XPS) data of the lithium products showed a signal at 54.58 eV, which is close to that of commercial lithium samples at 54.38 eV (FIG. 24). X-ray powder diffraction and inductively coupled plasma-optical emission spectroscopy (ICP-OES) were also utilized to characterize the products (FIG. 25). High-intensity peaks appeared at 20=32.50°, 36.200 of the XPS spectra were in good agreement with the reported data of lithium powder. In addition, ICP-OES results indicate that the lithium metal accounts about 0.64 mg (about 42.6%) of the sample. These results clearly confirmed the presence of lithium (0) species in the products. Furthermore, the reduction of lithium cation was supported by computation studies, showing that such a redox process is thermodynamically favored (ΔG=−51.82 kcal/mol) (data not shown). Without wishing to be bound by theory, it is believed that the above disclosure may represent a rare example of lithium cation reduction within an organic species, particularly within the borate anion of the present invention.

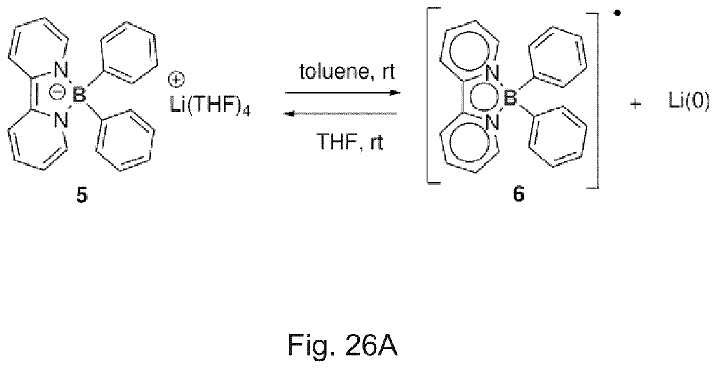

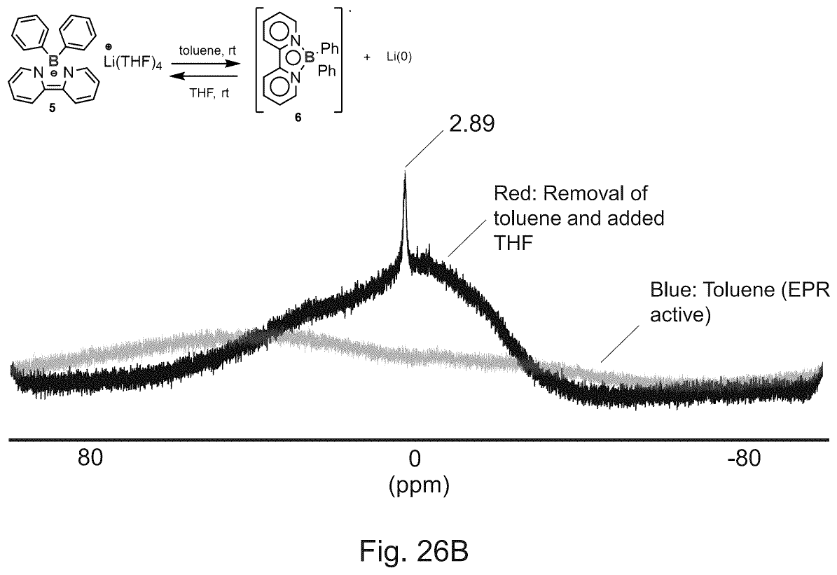

When THF was added to the mixture of compound 6 and in-situ generated Li(0), borate anion 5 was clearly regenerated (FIGS. 26A and 26B). Furthermore, when 12-crown-4 ether and compound 5 were mixed in toluene, no formation of compound 6 was observed (FIG. 6), as confirmed by the EPR (FIG. 7), indicating that the coordination of THF or crown ether is crucial for the stabilization of lithium cations in 5. Additionally, the reaction of compound 4 and PhLi in toluene generated compound 6 with a 94% yield (FIG. 5A). In these transformations, it is demonstrated that the choice of solvent can control the generation of boron radical or borate anion.

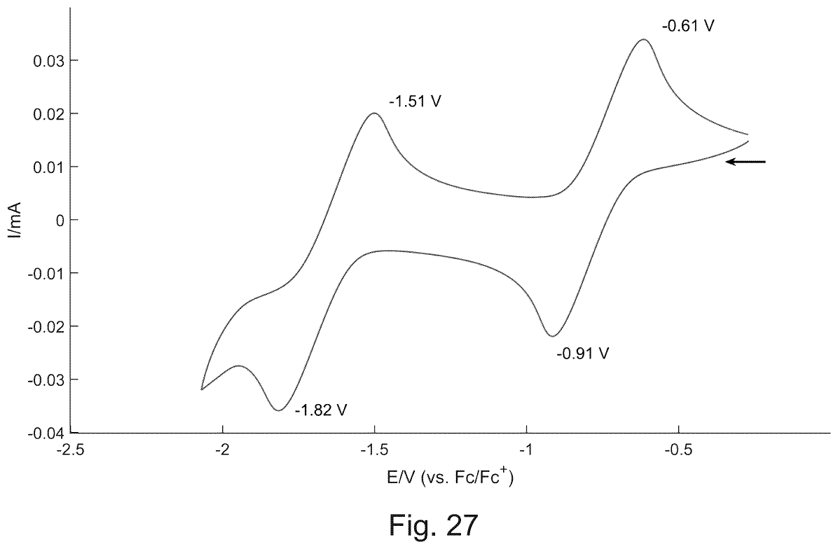

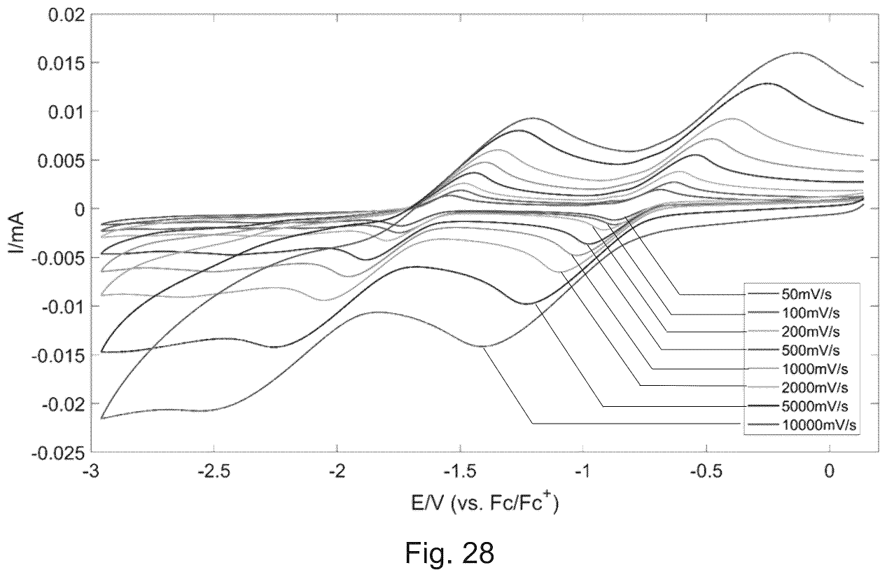

The redox properties of 6 were studied by cyclic voltammetry (CV) in THF solutions. A quasi-reversible process involving two reductions was observed in the CV spectra (FIG. 27). The second reduction occurs at −1.82 V vs. Fc/Fc⁺, attributed to the reduced anionic species of radical 6. Under electrochemical conditions, this borate anion can be oxidized to radical 6, as shown in the first oxidation potential at −1.51 V; the second oxidation appears at −0.61 V, indicating the formation of boron cations; the reduction of boron cations at −0.91 V regenerates the radical 6. Both the cationic and anionic derivatives of 6 were stable under electrochemical conditions (FIG. 28).

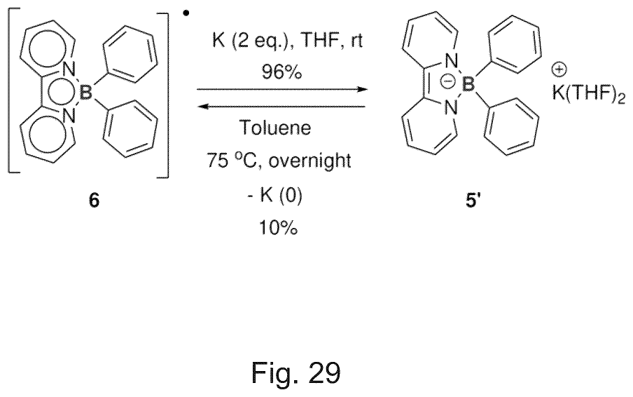

In agreement with the CV experiment, radical 6 can be reduced by potassium in THF, affording the borate anion 5′ in a 96% isolated yield (FIG. 29). Compound 5′ was fully characterized by NMR and HRMS spectra. Contrary to lithium borate anion 5, the potassium borate anion 5′ was stable in both THF and toluene, and no decomposition was observed at room temperature. However, when heating at 75° C. in toluene, 5′ was converted to radical 6 in a 10% isolated yield. And the reduction of K⁺ into metallic potassium was confirmed by ICP-OES, which shows that potassium metal accounts for about 0.099 mg od the sample.

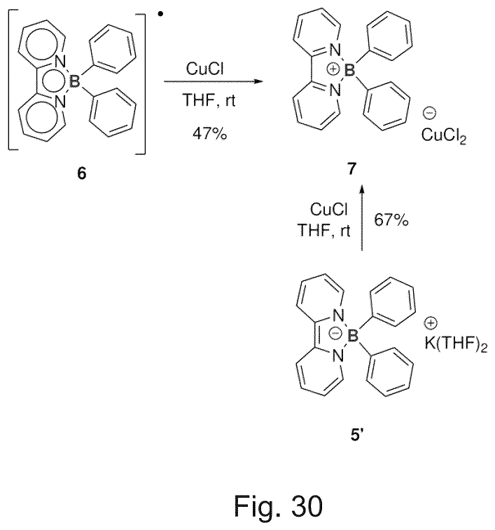

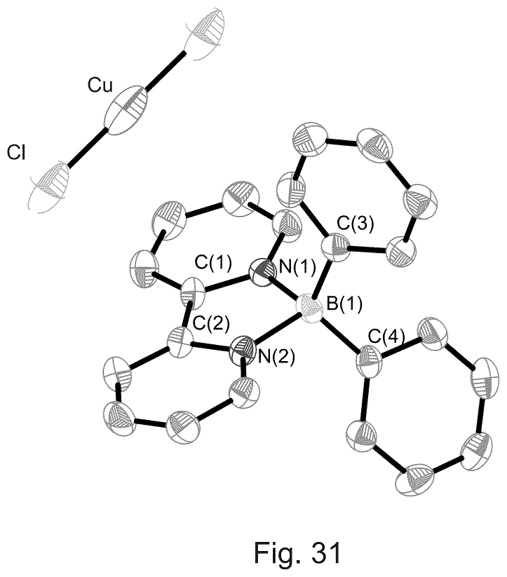

On the other hand, the radical 6 can be oxidized to boronium 7 by an excess of CuCl in a THF solution (FIG. 30). Compound 7 was successfully characterized by NMR, HRMS spectra, and single-crystal X-ray analyses (FIG. 31). The boron-containing frameworks of compounds 5, 6, and 7 bear similar geometries. However, the bond lengths of C1-C2 (1.359 Å), B1-N1 (1.564 Å), and B1-N2 (1.557 Å) in 5 are significantly shorter than those of 7 (1.469 Å, 1.601 Å, and 1.614 Å), revealing the non-aromatic feature of the two C₅N rings. Furthermore, boronium 7 can be obtained through the oxidation of borate anion 5′ (FIG. 30).

### Example 16

### Electronic Structure of Bipyridine-Stabilized Boron Compounds

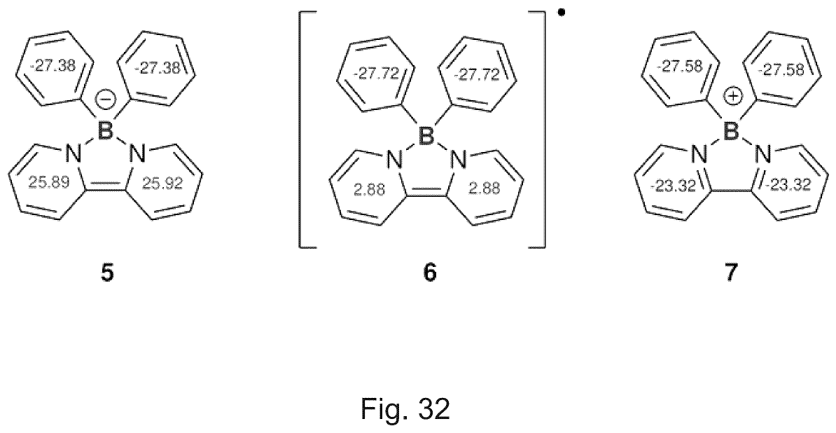

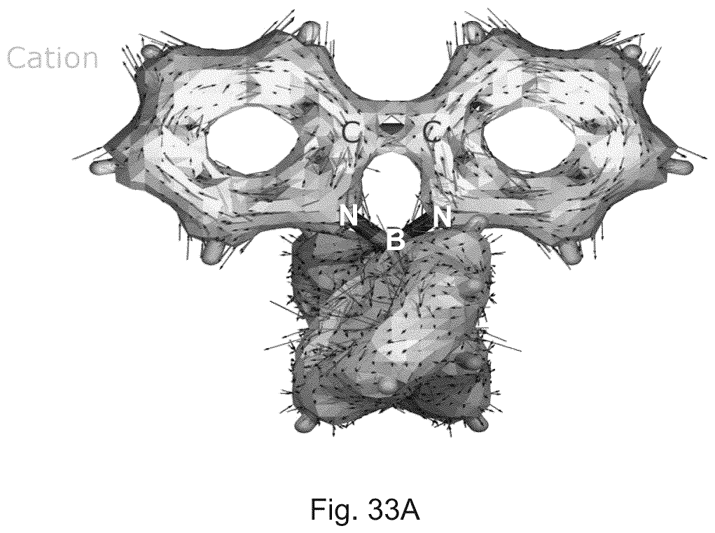

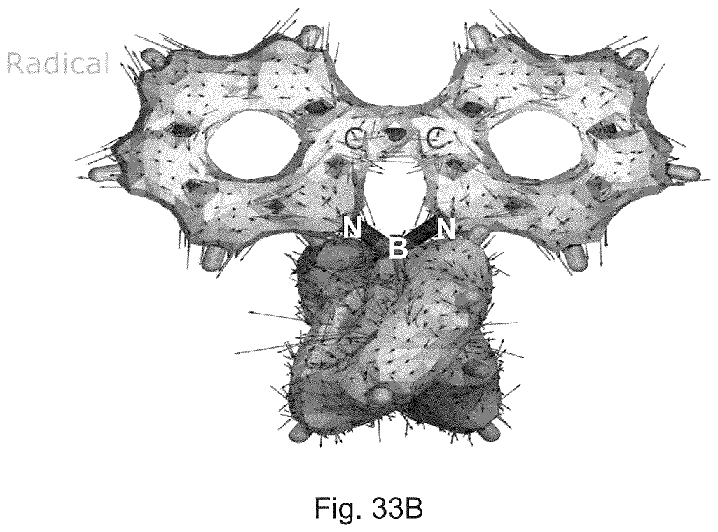

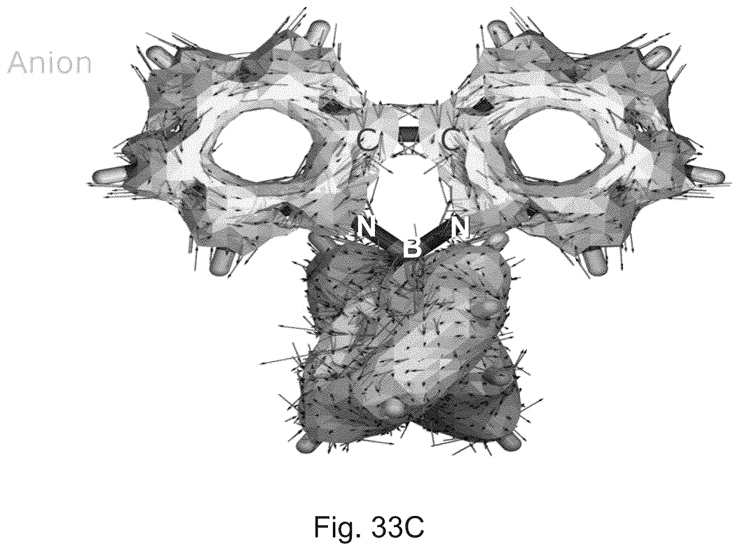

The aromatic characters of compounds 5, 6, and 7 were investigated through the nuclear independent chemical shift values at 1 Å above the center of each ring (NICS(1)). In general, NICS values of the two phenyl rings substituted at the boron atoms are negative and similar in these three species. In structures 5 and 6, the two C₅N rings are dearomatized with positive NICS(1) values, especially for the borate anion 5, showing NICS(1) values of 25.89 and 25.92 (FIG. 32). In comparison, the two C₅N rings in 7 are aromatic and exhibit negative NICS(1) values (−23.32). The extent of π-electron delocalization in 5-7 was further assessed through the analysis of current-induced density (ACID) anisotropy (FIGS. 33A-33C). These results are in good agreement with their structural information.

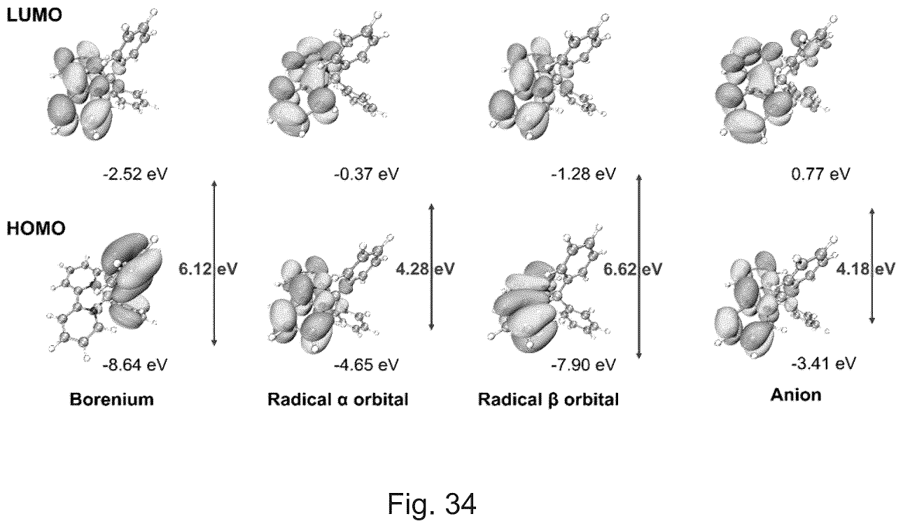

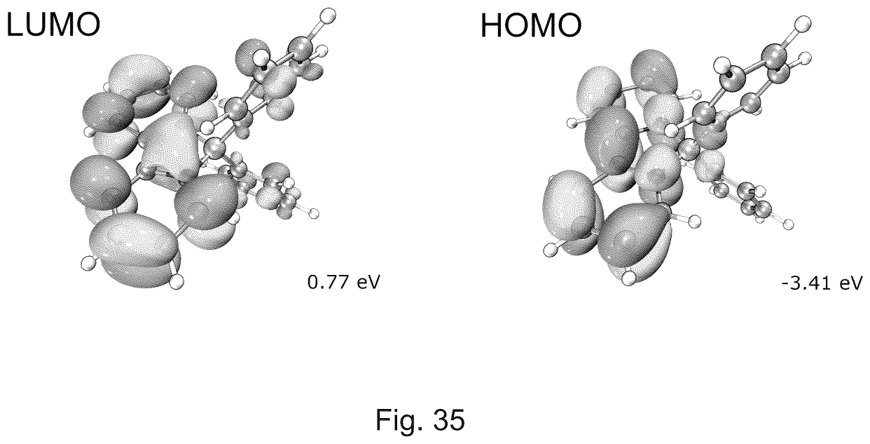

Besides, DFT computation studies were performed to elucidate the electronic structure of compounds 5, 6, and 7. The LUMOs of these compounds are all distributed on the bipyridine rings. For anion 5 and radical 6, the bipyridine moieties also contribute mostly to the HOMOs, whereas the HOMO of boronium 7 is located on the two phenyl rings (FIG. 34). Moreover, anion 5 has the smallest HOMO-LUMO energy gap (4.18 eV) among the three derivatives (FIG. 35). These results indicate that the reactivity of compound 5 comes from the bipyridine moieties.

### Example 17

### Two-Electron-Transfer Reactivity of Borate Anion 5′

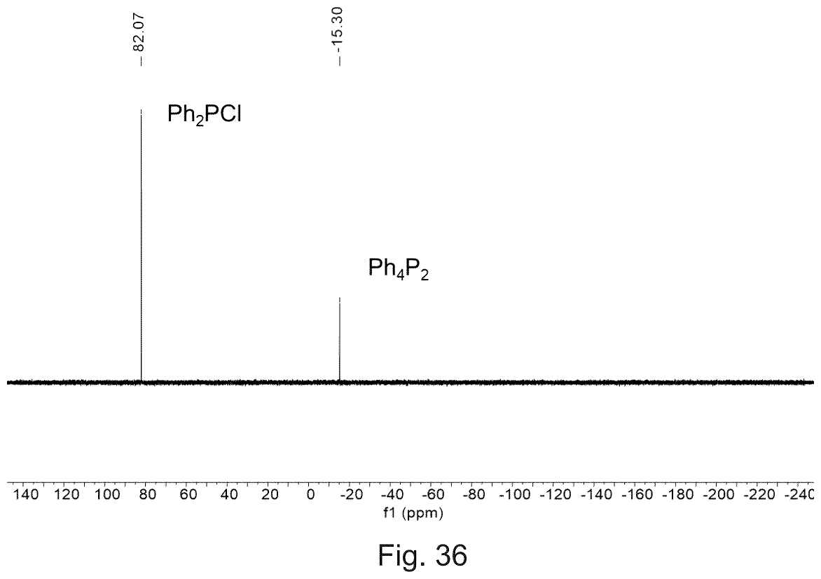

In view of the two-electron-transfer reactivity of 5′, the application of borate anion 5′ in reductive-coupling reactions was explored. PPh₂Cl was chosen as the substrate to test the reactivity. The reaction of 5′ and PPh₂Cl (1:2) in THF solution was monitored at room temperature (FIG. 9A). Indeed, a P—P coupling product, P₂Ph₄, was isolated as the final product, showing a signal at −15.01 ppm in the ³¹P NMR spectra. The borate anion 5′ was converted to the boronium 8 in 80% isolated yield, confirming that compound 5′ acted as a two-electron-reducing agent in this reaction. Additionally, when a 1:1 mixture of the radical 6 and PPh₂Cl reacted in THF at room temperature, P₂Ph₄ was isolated in 86% yield (FIG. 9B). In comparison, when using sodium naphthalene as the reducing reagent, a 21% generation of P₂Ph₄ was observed based on the ³¹P NMR (FIG. 36).

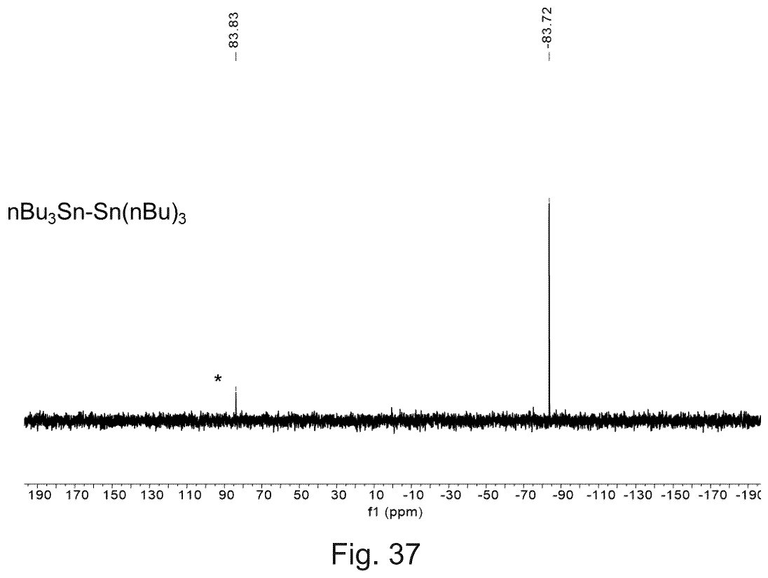

Moreover, compound 5′ can also facilitate other element-element coupling reactions (FIGS. 10-13). For example, nBu₃SnC1 can be converted to nBu₃Sn—Sn(nBu)₃ in the presence of 5′ (FIG. 10). The formation of the Sn—Sn bond in the final product was confirmed by the ¹¹⁹Sn-NMR spectra, showing a signal at −83.72 ppm attributed to the Sn—Sn moieties (FIG. 37). In a similar manner, the formation of Se—Se and Ge—Ge can be realized (FIGS. 11 and 12). When the ammonium salt NHEt₃Cl reacted with 5′, dihydrogen gas was released, confirmed by the online gas chromatography (FIGS. 13, 15A-15C). A clean generation of NEt₃ was observed from the ¹H NMR spectra (FIG. 14). When using sodium naphthalene as the reducing reagents in these reactions, the coupling products can't be obtained.

Additionally, compound 5′ can achieve reductive reactions on nitrogen-containing aromatic compounds. The reaction of pyridine and 5′ afforded the C—C coupling product, 4,4′-bipyridine, in 24% isolated yield after quenching with methanol (FIG. 16). Furthermore, compound 5′ can promote Birch reduction of acridine, generating 9,10-dihydroacridine in a 58% isolated yield (FIG. 17). These two reactions can't be realized using sodium naphthalene as a reducing reagent.

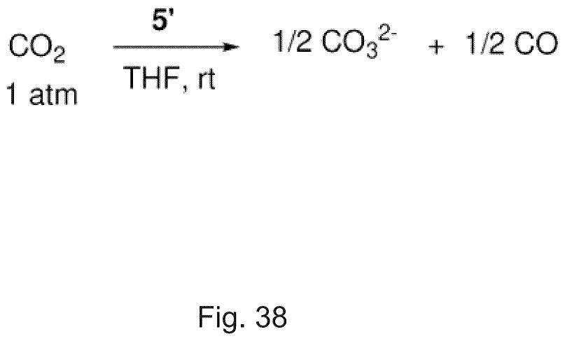

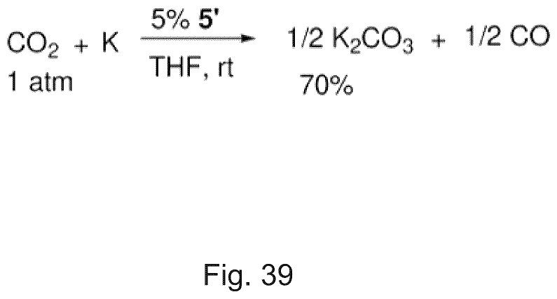

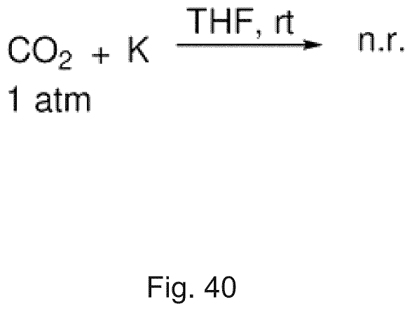

Finally, the two-electron reduction of CO₂ was also examined. The reaction of compound 5′ and an excess of CO₂ (1 atm) was conducted at room temperature in THF solution (FIG. 38). This reaction generated CO₃²⁻, confirmed by the ¹³C-NMR (FIG. 19), and CO as the final product, characterized by the online gas chromatography (FIGS. 18A and 18B). Notably, this reaction can be performed in a catalytic fashion, where 5 mol % 5′ was added to the potassium in THE with 1.2 equiv. CO₂(1 atm), affording K₂CO₃ in 70% yield (FIG. 39). In the absence of 5′, potassium was barely consumed under CO₂ (1 atm) after one week (FIG. 40). Without wishing to be bound by theory, it is believed that the present disclosure represents a rare example of transition-metal-free system for the selective reduction of CO₂ into CO.

The invention has been given by way of example only, and various other modifications of and/or alterations to the described embodiment may be made by persons skilled in the art without departing from the scope of the invention as specified in the appended claims.

1. An organoboron compound for reductive synthesis comprising a structure of Formula (I): 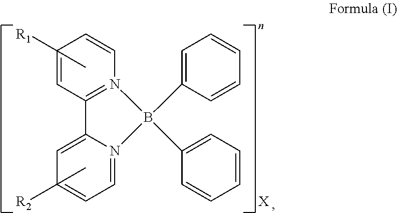
wherein R₁ and R₂ each are mono-, di- or tri-substitution; n is an integer; and X, if present, is a counterion.

2. The organoboron compound as claimed in claim 1, wherein R₁ and R₂ are each independently selected from the group consisting of hydrogen, alkyl, alkoxy and a combination thereof; and with n and X as defined above.

3. The organoboron compound as claimed in claim 1, wherein R₁ and R₂ are each independently selected from the group consisting of hydrogen, C1-C5 linear or branched alkyl, C1-C5 alkoxy and a combination thereof; and with n and X as defined above.

4. The organoboron compound as claimed in claim 1 comprising a structure of Formula (IA): 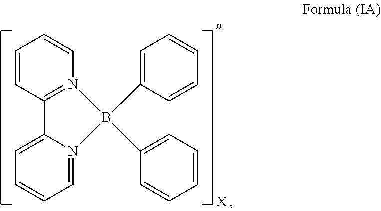
wherein n is 0 or −1; and X, if present, comprises a positive counterion.

5. The organoboron compound as claimed in claim 4 comprising a structure of Formula (II):

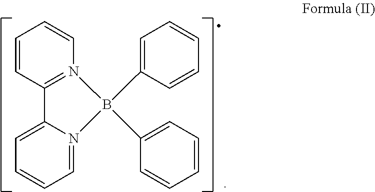

6. The organoboron compound as claimed in claim 4 comprising a structure of Formula (III): 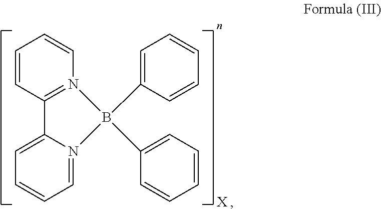
with X being the positive counterion.

7. The organoboron compound as claimed in claim 6 comprising a structure of Formula (IIIA) or Formula (IIIB):

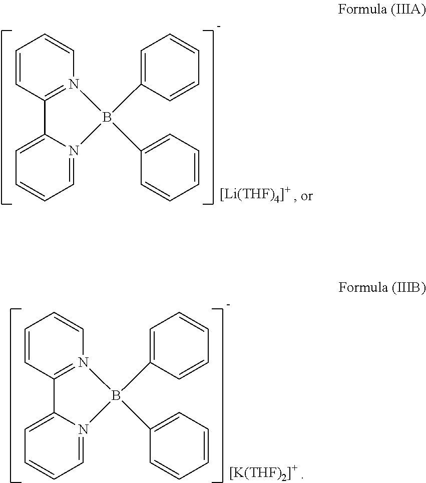

8. The organoboron compound as claimed in claim 1, wherein the reductive synthesis comprises any one of metallic lithium (Li(0)) formation, P—P coupling reaction, Sn—Sn coupling reaction, Se—Se coupling reaction, Ge—Ge coupling reaction, H—H coupling reaction, C—C coupling reaction, alkene reduction reaction and CO₂ reduction reaction.

9. A method for preparing an organoboron compound as claimed in claim 1 comprising the steps of:
(a) providing a first precursor having a structure of Formula (IV): 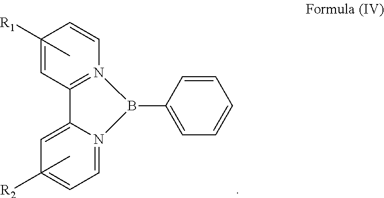
with R₁ and R₂ each being the mono-, di or tri substitution as defined above;
(b) converting the first precursor into the organoboron compound.

10. The method as claimed in claim 9, wherein the first precursor has a structure of Formula (IVA):

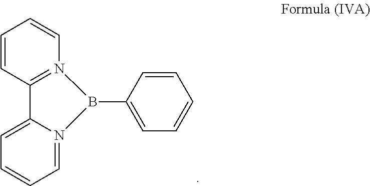

11. The method as claimed in claim 10 comprising the step of converting the first precursor having the structure of Formula (IVA) into the organoboron compound at room temperature.

12. The method as claimed in claim 11, wherein the converting step includes stirring a first reaction mixture comprising the first precursor having the structure of Formula (IVA), phenyllithium and THF at room temperature for at least 8 hours to form the organoboron compound having the structure of Formula (II).

13. The method as claimed in claim 12, wherein the first precursor having the structure of Formula (IVA) and phenyllithium have a molar ratio of about 1:1.5.

14. The method as claimed in claim 11, wherein the converting step includes stirring a second reaction mixture comprising the first precursor having the structure of Formula (IVA), phenyllithium and toluene at room temperature for at least 8 hours to form the organoboron compound having the structure of Formula (IIIA).

15. The method as claimed in claim 14, wherein the first precursor having the structure of Formula (IVA) and phenyllithium have a molar ratio of about 1:1.

16. The method as claimed in claim 14, wherein the converting step further includes stirring a third reaction mixture comprising the organoboron compound having the structure of Formula (IIIA) and toluene at room temperature for at least 8 hours to form the organoboron compound having the structure of Formula (II).

17. The method as claimed in claim 11, wherein the converting step includes stirring a fourth reaction mixture comprising the organoboron compound having the structure of Formula (II), potassium and THF at room temperature for at least 8 hours to form the organoboron compound having the structure of Formula (IIIB).

18. The method as claimed in claim 17, wherein the organoboron compound having the structure of Formula (II) and potassium have a molar ratio of about 1:2.

19. The method as claimed in claim 17, wherein the organoboron compound having the structure of Formula (IIIB) is reversibly convertible to the organoboron compound having the structure of Formula (II).

20. The method as claimed in claim 19, wherein the organoboron compound having the structure of Formula (IIIB) is reversibly converted to the organoboron compound having the structure of Formula (II) when the organoboron compound having the structure of Formula (IIIB) is heated in toluene at a temperature of about 70° C. to about 80° C. for at least 8 hours.
